(19) United States
(12) Patent Application Publication
(10) Pub. No.: US 2025/0245598 A1
(43) Pub. Date: Jul. 31, 2025

(54) System and Method for Optimizing Sustainability for a Real-World System

(71) Applicant: CDM Smith Inc., Boston, MA (US)

(72) Inventors: Melissa A. Harclerode, Caldwell, NJ (US); Timothy P. Kinny, Apple Valley, MN (US); Mark Maimone, Huntington Station, NY (US)

(21) Appl. No.: 18/747,113

(22) Filed: Jun. 18, 2024

Related U.S. Application Data
(60) Provisional application No. 63/625,784, filed on Jan. 26, 2024.
(60) Provisional application No. 63/648,108, filed on May 15, 2024.

(51) Int. Cl. G06Q 10/0637; G06Q 10/067

(52) U.S. Cl. CPC G06Q 10/06375; G06Q 10/067

(57) ABSTRACT

Embodiments optimize sustainability for a real-world system. One such embodiment obtains multiple-criteria decision analysis (MCDA) results and criteria weighting values used to generate the MCDA results. The MCDA results include candidate sustainability techniques for the real-world system. Each of the candidate sustainability techniques is associated with a corresponding sustainability score. Variable(s) are identified from at least one of parameters of the candidate sustainability techniques and the obtained criteria weighting values. Based on the identified variable(s), using a probabilistic model, a simulated results distribution is generated. Each simulated result of the simulated results distribution is associated with simulated value(s) of the variable(s). Based on a comparison of the generated simulated results distribution and the obtained MCDA results, the obtained MCDA results are transformed by modifying a ranking of the candidate sustainability techniques and associated corresponding sustainability scores, thereby optimizing sustainability for the real-world system.

### RELATED APPLICATIONS

This application claims the benefit of U.S. Provisional Application No. 63/625,784, filed on Jan. 26, 2024, and 63/648,108, filed on May 15, 2024. The entire teachings of the above applications are incorporated herein by reference.

### BACKGROUND

Interest in sustainability for real-world systems has grown over time.

### SUMMARY

Sustainability impacts users across, e.g., the transportation, environment, water, and natural resource sectors. However, existing approaches to analyzing sustainability in the engineering field are typically focused on hard metrics that are easily quantifiable and often do not appropriately account for environmental or societal considerations. Therefore, functionality with flexibility to adapt to multiple different types of metrics is needed. Embodiments provide such functionality.

An example embodiment is directed to a computer-based system for optimizing sustainability for a real-world system. The computer-based system includes at least one processor and a memory with computer code instructions stored thereon. The at least one processor and the memory, with the computer code instructions, are configured to cause the computer-based system to obtain (i) multiple-criteria decision analysis (MCDA) results and (ii) criteria weighting values used to generate the MCDA results. The MCDA results include candidate sustainability techniques for the real-world system. Each of the candidate sustainability techniques is associated with a corresponding sustainability score. The at least one processor and the memory, with the computer code instructions, are further configured to cause the computer-based system to identify at least one variable from at least one of (i) parameters of the candidate sustainability techniques and (ii) the obtained criteria weighting values. The at least one processor and the memory, with the computer code instructions, are further configured to cause the computer-based system to, based on the identified at least one variable, using a probabilistic model, generate a simulated results distribution. Each simulated result of the simulated results distribution is associated with at least one simulated value of the identified at least one variable. The at least one processor and the memory, with the computer code instructions, are further configured to cause the computer-based system to, based on a comparison of the generated simulated results distribution and the obtained MCDA results, transform the obtained MCDA results by modifying a ranking of the candidate sustainability techniques and associated corresponding sustainability scores, thereby optimizing sustainability for the real-world system.

In an example embodiment, the probabilistic model may be a Monte Carlo model, a stochastic simulation model, another probabilistic model, or a combination thereof.

According to an example embodiment, the at least one processor and the memory, with the computer code instructions, may be further configured to cause the computer-based system to identify the at least one variable based on a value of the at least one variable meeting or exceeding a threshold value.

In an example embodiment, the at least one processor and the memory, with the computer code instructions, may be further configured to cause the computer-based system to store the generated simulated results distribution in a metrics repository. According to another example embodiment, the at least one processor and the memory, with the computer code instructions, may be further configured to cause the computer-based system to generate the simulated results distribution based on at least one metric stored in a metrics repository.

According to an example embodiment, the criteria weighting values may be triple bottom line (TBL) criteria weighting values relating to the real-world system.

In an example embodiment, the real-world system may be a transportation system, a waste management system, a water system, an energy system, an industrial system, an ecosystem, or a natural resource system.

According to an example embodiment, the at least one processor and the memory, with the computer code instructions, may be further configured to cause the computer-based system to output a graph representing the generated simulated results distribution.

Another example embodiment is directed to a computer-implemented method for optimizing sustainability for a real-world system. In such an embodiment, the method is configured to implement any embodiments, or combination of embodiments, described herein.

Yet another example embodiment is directed to a non-transitory computer program product for optimizing sustainability for a real-world system. The computer program product includes a computer-readable medium with computer code instructions stored thereon. The computer code instructions are configured, when executed by at least one processor, to cause the at least one processor to implement any embodiments, or combination of embodiments, described herein.

It is noted that embodiments of the computer-based system, computer-implemented method, and non-transitory computer program product may be configured to implement any embodiments, or combination of embodiments, described herein.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a block diagram of a sustainability analytics framework according to an example embodiment.

FIG. 2 is a chart showing exemplary industries and projects that the framework of FIG. 1 can be applied to, according to an example embodiment.

FIG. 3 is a table of exemplary values used in a Multi-Criteria Decision Analysis (MCDA) according to an example embodiment.

FIG. 4 is a flow diagram of a process for sensitivity testing according to an example embodiment.

FIG. 5 is an image of a sample MCDA dashboard according to an example embodiment.

FIG. 6 is an image of a sample MCDA dashboard according to another example embodiment.

FIG. 7 is a block diagram of exemplary selection criteria according to an example embodiment.

FIG. 8 is a block diagram of exemplary initiatives according to an example embodiment.

FIG. 9 is a block diagram of a carbon reduction calculator according to an example embodiment.

FIG. 10 is a user interface for a carbon reduction calculator according to an example embodiment.

FIG. 11 is a user interface for an emissions calculator according to an example embodiment.

FIG. 12 is a user interface for an emissions calculator according to another example embodiment.

FIG. 13 is a flowchart of a method for creating a carbon reduction roadmap according to an example embodiment.

FIG. 14 is a bar graph of pollutants emissions according to an example embodiment.

FIG. 15 is a flow diagram of a process for determining a system boundary according to an example embodiment.

FIG. 16 is a flow diagram of a process for performing an existing conditions assessment according to an example embodiment.

FIG. 17 is a flow diagram of a process for filtering/screening sustainable initiatives according to an example embodiment.

FIG. 18 is a flow diagram of a process for performing a triple bottom line (TBL) assessment according to an example embodiment.

FIG. 19 is a table of stopped delay savings and peak traffic volume for roundabouts and diverging diamond interchanges (DDIs) according to an example embodiment.

FIG. 20 is a flow diagram of a process for criteria setting/weighting and MCDA according to an example embodiment.

FIG. 21 is a user interface for an automated analysis tool according to an example embodiment.

FIG. 22 is a flowchart of a method for optimizing sustainability for a real-world system according to an example embodiment.

FIG. 23 is a block diagram of an example embodiment of an internal structure of a computer in which various embodiments of the present disclosure may be implemented.

### DETAILED DESCRIPTION

A description of example embodiments follows.

### Introduction

Providing balanced and accurate analysis of project or option sustainability is emerging as an important component of corporate decision-making and Government regulatory requirements. In the architecture, engineering, and construction industries, Applicant-Assignee CDM Smith Inc. (Boston, MA) practices sustainability by emphasizing responsible use of natural, monetary, and societal resources. Applicant-Assignee seeks to lessen project life cycle impacts by identifying and applying measures that will reduce an overall environmental footprint (e.g., emissions, water stewardship, and waste management) and potential community impacts (e.g., land use, public health, environmental justice, and responsible materials sourcing). To assist with this endeavor, Applicant-Assignee has developed embodiments that provide an analytical framework to best serve users and distinguish Applicant-Assignee from competitors in the engineering field.

According to an example embodiment, a Sustainability Analytics Framework (SAF) may facilitate a collaborative and efficient cross-practice integration of technical information and analysis of initiatives that allows for informed decision-making considering wholesale sustainability of actions across various sectors. The framework may utilize technical material to maximize a sustainable outcome of project activities. One goal may be to maximize environmental, social, and monetary benefits that address user needs and aligns with their values, while using an efficient and technically robust approach.

In an example embodiment, a SAF may provide an approach to develop planning roadmaps and prioritize sustainable initiatives informed by a data-backed assessment of natural resource and socioeconomic impact, energy use, water use, and/or greenhouse gas (GHG) and criteria air pollutant (CAP) emissions. According to another example embodiment, a SAF may start with a baseline assessment and then evaluate multiple sustainable solutions or initiatives against the baseline for comparison. In yet another example embodiment, an analysis may use quantitative and/or qualitive data for user-selected sustainability and/or performance analysis criteria. According to an example embodiment, input data may be project specific, although an analysis may utilize both internally developed calculations and values.

In an example embodiment, a SAF result may provide a clear prioritization of initiatives based on sustainability criteria that are informed by users' and/or stakeholders' values to help a user have a defensible, data-backed roadmap of sustainable initiatives and allow for better ease of investment.

### Terms and Definitions

The term “strategy” as used herein generally refers to an overarching plan developed by an organization to integrate sustainable practices into its overall business operations and decision-making processes. A strategy may encompass long-term goals, objectives, and/or actions that address, e.g., environmental, social, and economic aspects of sustainability.

The term “initiative” as used herein generally refers to a specific project, program, or action taken by an organization as a part of a strategy to achieve a particular sustainability issue or goal. An initiative may be more focused and/or targeted than a strategy, and may address specific challenges or opportunities within a broader sustainability strategy.

The term “criteria” as used herein generally refers to a set of specific standards, principles, and/or factors that may be used to assess and/or prioritize initiatives or projects based on, e.g., their environmental, social, and economic sustainability.

The term “consultant” as used herein generally refers to an individual or a company that is hired to perform specific tasks, provide services, and/or deliver goods as outlined in a contractual agreement. A consultant may be referred to interchangeably as an “operator.”

The term “client” as used herein generally refers to an individual, organization, or entity that procures services, expertise, and/or products of another party. A client may be referred to interchangeably as a “user.”

The term “stakeholder” as used herein generally refers to any individual or group that has an interest, influence, and/or concern in an outcome of a project, business, and/or initiative. A stakeholder can include an internal or external party affected by or affecting a project.

### Applied Example

In an example embodiment, an operator may utilize a SAF on behalf of a user to formulate a comprehensive sustainability strategy aligned with the user's long-term sustainability goals and/or objectives. The strategy may include specific initiatives developed by the operator. To assess and prioritize these initiatives, the operator may employ sustainability criteria informed by the user and/or stakeholders.

### Sustainability Analytics Framework

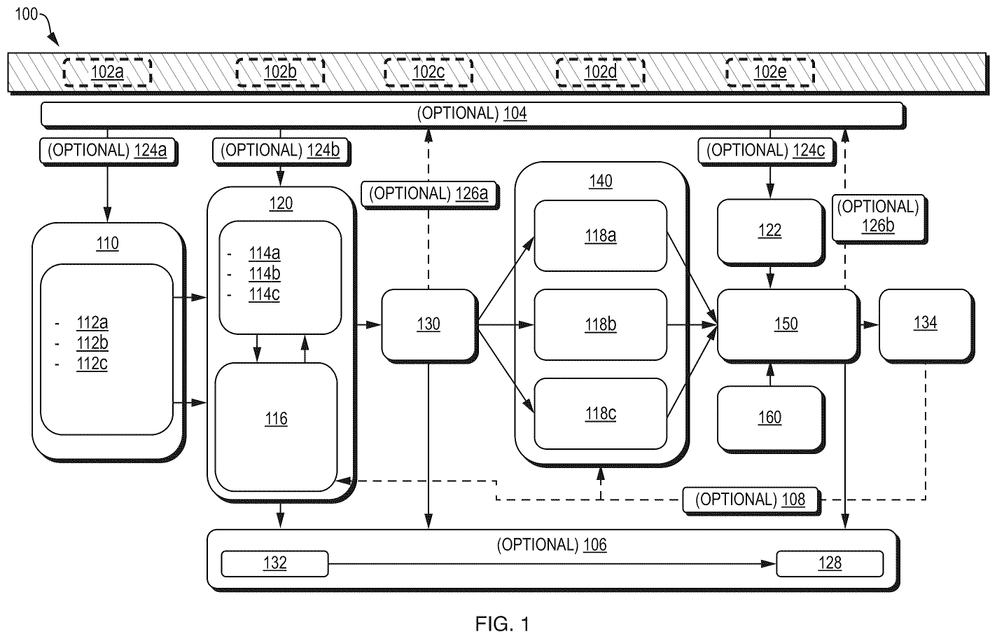

FIG. 1 is a block diagram of a sustainability analytics framework 100 according to an example embodiment.

The framework 100 includes five exemplary steps 102a-102e. In an example embodiment, as shown in FIG. 1, the steps 102a-102e may be completed sequentially. According to another example embodiment, a level of detail and/or analysis completed in each step 102a-102e may vary depending on the purpose of the analysis, number of options being considered, size of a user organization, data availability, and/or user constraints (e.g., budget constraints), among other examples.

There are three additional components 104, 106, and 108 that may be optionally included as a “best practice.” The application of these optional components 104, 106, and 108 may be driven by user scope constraints and/or user preferences. These three optional components are:
a) Stakeholder Consultation and Input 104;
b) Sustainable Initiative Uncertainty 106; and
c) Feedback Loop for Continuous Improvement 108.

A description of each of the five exemplary steps 102a-102e is provided below.

### Exemplary Step: Determine System Boundary

The first exemplary step 102a may include determining a system boundary 110 to help with establishing objectives, bounds, and/or limitations early in an analysis. This step 102a may help to bring stakeholders into alignment to facilitate building consensus and/or buy—in on how “sustainability” is defined, evaluated, reported on, and/or how analysis findings are used.

The stakeholder consultation and input component 104 may optionally be used when determining a system boundary 110, although the optional component 104 may just be limited to a primary stakeholder being a user or a broad array of stakeholders. A goal of this optional task 104 may be to engage stakeholders in development of a strategy, and collect their perspectives on how a current system contributes to environmental impacts like GHG emissions, water usage, and/or waste generation, among other examples. The types of stakeholders and their level of participation may vary between users and/or projects. Outreach strategies for each of these stakeholders may be defined in the step 102a.

The component 110 of determining a system boundary may include setting overarching objectives and/or principles for successful use of the framework 100.

To further determine the system boundary 110, establishment of objectives 112a for an analysis may be included. These objectives 112a may be different from, e.g., user/proponent sustainability and/or GHG/carbon reduction goals, and may address what an operator of the framework 100 seeks to achieve by utilizing the framework 100. Establishing the objectives 112a may include identify, e.g., the top five feasibility objectives. As part the component 112a, a data user and/or a use of an analysis may be defined.

Examples of these objectives 112a may include identifying, e.g., the top ten GHG reduction initiatives an organization should prioritize based on a triple bottom line (TBL) assessment of environmental, social, and monetary criteria. Establishing the objectives 112a may include understanding a difference between, e.g., water reuse and reduction initiatives, when only considering monetary/financial criteria compared to holistically considering sustainability criteria for environmental and/or social factors. Further, establishing the objectives 112a may allow for understanding sensitivity of decision criteria to better inform decision-making.

Defining a scale and bounds of an analysis 112b may be another step when determining the system boundary 110. This component 112b may include specific industries and/or sectors an analysis may be limited to (e.g., transportation, waste, water, etc.), as well as a geographic and/or temporal scale of a study (e.g., spatially limited to a region or state and/or temporally focused on short-term or long-term initiatives). A scale and/or boundaries defined by the component 112b may inform a subsequent selection of screening criteria 114c, SMART (specific, measurable, achievable, relevant and time-bound) goals, and/or refinement of options and jurisdictional limitations relevant to an analysis. Similarly, the component 112b may inform an existing condition assessment and/or identification or selection of sustainability initiatives 114a and policies relevant to an analysis.

Yet another step when determining the system boundary 110 may be establishing a stakeholder outreach strategy 112c. The types of stakeholders and their level of participation in a process will vary between users and projects. An overall outreach strategy for various stakeholder groups throughout an analysis may be defined by the component 112c.

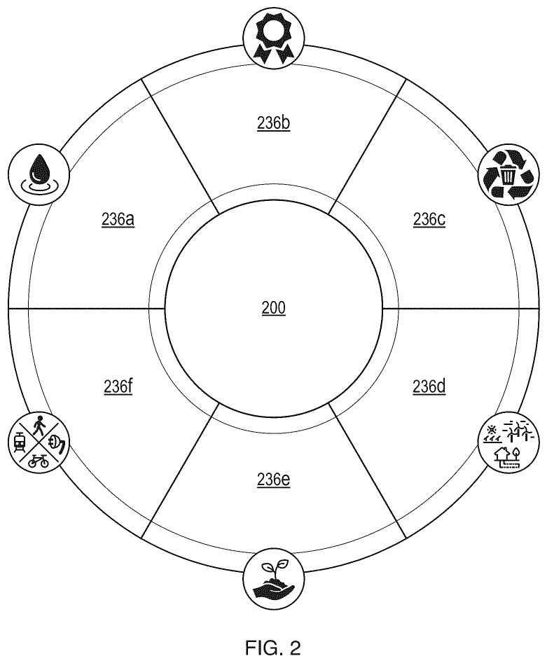

An example of specific industries or sectors include water, transportation, solid waste management, energy, sustainable ecosystems and natural resource management, sustainable remediation, and/or environmental social governance and sustainability reporting. Further details of exemplary industries, sectors, and projects are discussed hereinbelow in relation to FIG. 2.

FIG. 2 is a chart showing exemplary industries and projects 236a-236f that a sustainability analytics framework 200 can be applied to, according to an example embodiment.

As shown in FIG. 2, Water industry projects 236a may include the following examples:
a) Inflation Reduction Act (IRA) GHG Reduction Fund and Justice40 Initiative;
b) Green stormwater infrastructure (GSI) sustainable design and performance metrics;
c) Feasibility study and energy (biogas) recovery sustainability assessment; and/or
d) Water stewardship plan and advisory committee.

Environmental Social Governance (ESG) and Sustainability Reporting projects 236b may include the following examples:
a) Sustainability certification support;
b) ESG framework analysis, e.g., Science Based Targets initiative (SBTi), Carbon Disclosure Program (CDP), Global Reporting Initiative (GRI), Sustainability Accounting Standards Board (SASB), etc.;
c) Materiality assessments;
d) Institute for Sustainable Infrastructure (ISI) Envision; and/or
e) Federal Emergency Management Agency (FEMA) Benefit-Cost Analysis (BCA) Toolkit.

Sustainable Ecosystems and Natural Resource Management projects (not shown) may include the following examples:
a) Sustainability assessments and land monitoring (e.g., biodiversity, biome health, etc.);
b) Comprehensive sustainable land management strategies;
c) Environmental ethics evaluation; and/or
d) Strategic examination of environmental risks/issues.

Solid Waste Management industry projects 236c may include the following examples:
a) Sustainable landfill design and mining;
b) Sustainable waste-to-energy and biogas recovery; and/or
c) Curbside recycling/materials recovery facility (MRF) and composting systems.

Energy industry projects 236d may include the following examples:
a) Decarbonization and net zero energy strategy;
b) Sustainable renewable/geothermal energy site setting and design; and/or
c) Low carbon fuels and construction materials.

Sustainable Remediation projects 236e may include the following examples:
a) Sustainable site measures and practices;
b) Feasibility study sustainability benefits and impacts; and/or
c) Sustainable design and performance metrics.

Transportation industry projects 236f may include the following examples:
a) Bipartisan Infrastructure Law (BIL) Carbon Reduction Strategy and Justice40 Initiative;
b) Use of system, capital projects, and/or operations and maintenance (O&M) sustainable measures and performance metrics; and/or
c) Airport sustainability plans.

The framework 200 may analyze example factors including the following:
a) GHG and air pollutant emissions;
b) Public health/community impact;
c) Environmental justice;
d) Societal cost/benefits;
e) Financial analysis;
f) Natural resources/land use; and/or
g) Human and labor rights.

### Exemplary Step: Existing Conditions Assessment

Referring again to FIG. 1, the step 102b of the framework 100 may include performing an existing conditions assessment 120. The existing conditions assessment 120 may include several exemplary steps. First, a framework operator may identify data that may be obtained to establish a project or portfolio baseline 116 (e.g., baseline GHG emissions, water usage, waste generation, etc.). Example data used to establish the baseline 116 may also or alternately include energy/water use and/or recovery, GHF emissions forecasting, community demographics, and/or stakeholder values. To continue, an operator may then request such data from a user including items such as current operational conditions. An operator may in turn identify and/or categorize various data to organize the baseline 116 into categories (e.g., O&M, capital projects, etc.). Once baseline categories are established, an operator may then establish a relevant scenario upon which the baseline(s) are defined. For example, this may include setting a baseline year based on available data. After this step, any calculations may be performed to obtain a desired result (e.g., electricity use is translated to GHG emissions). Finally, a baseline may be presented and displayed in formats suitable to a user and any relevant stakeholders.

Information collected during this step 102b may inform identification of sustainable initiatives to achieve primary sustainability/ESG (environmental, social, and corporate governance) performance goals, as well as help determine applicable indicators, metrics, tools, and/or data to evaluate TBL—e.g., people, planet, and profit-benefits and costs of technologies and strategies in subsequent framework 100 steps.

### Exemplary Step: Initiative Filter and Screen

As shown in FIG. 1, after determining the existing conditions 120 of a project or operation, the step 102c may include applying a filter/screen process 130 to identify any critical shortcomings and evaluate initiatives against common criterion that is developed in conjunction with a user and relevant stakeholders. The filter/screen process 130 may seek to identify those initiatives that are best suited to more detailed consideration. The step 102c may also be utilized to refine a large pool of initiative options into a refined list that is more manageable to carry forward into the step 102d, which may consume the bulk of effort in the framework 100.

A stakeholder survey is a format that can be utilized as part of the optional stakeholder consultation and input component 104 (refer to the section titled “Additional Optional Components” below for more details), to help ensure that only initiatives aligned with user/stakeholder sustainability goals 114b and those of planning partners are further analyzed.

Elimination of an initiative in the filter/screen process 130 may not discount the initiative from inclusion in a final report. Initiatives that do not progress in this analysis 130 may still warrant further investigation for development or implementation on different timelines.

### Exemplary Step: Triple Bottom Line Assessment

Following the screening 130 of initiatives, a TBL assessment 140 may be conducted as part of the step 102d to evaluate selected initiatives that aligned with a user and stakeholder's sustainability criteria (i.e., those initiatives carrying forward from the step 102c).

The TBL assessment 140 may evaluate sustainability criteria that represent monetary 118a, environmental 118b, and/or social 118c benefits and disbenefits of each sustainability initiative 114a, beyond just carbon emission reductions. Common criteria considered by the TBL assessment 140 may include, e.g., carbon reductions, impacts to infrastructure/operations, cost effectiveness, jurisdictional/policy/legal limitations, alignment with existing plans, environmental justice and social equity considerations, environmental stewardship, community and/or worker safety, and other public health benefits. Example lists of TBL criteria can be seen below in Tables 1A-1C. Tables 1A-1C provide example lists of the monetary (e.g., financial/economic) 118a, environmental (e.g., planet-related) 118b, and social (e.g., people-related) 118c criteria that may be analyzed to determine an initiative's benefits and costs.

TABLE 1A
Example criteria that can be analyzed in a framework

| Overall | | |
|---|---|---|
| Allocation | Criterion | Metrics/Details |
| Environmental | Carbon reductions | Net change in carbon emissions or embodied carbon |
| Environmental | Climate resiliency | Anticipated opportunity to positively impact Climate |
| | opportunities (or | Change resiliency |
| | co-benefits) | |
| Environmental | Land use burden | Land burden and land use type |
| Environmental | CAP emission | Net change in CAPs emissions, e.g., net change in |
| | reductions | particulate matter (PM) 2.5, PM 10, volatile organic |
| | | compounds (VOCs), carbon monoxide (CO), nitrogen |
| | | oxides (NOx), and sulfur oxides (SOX). |
| Environmental | Impacts to water | This criterion reflects an extent a proposed option could |
| | | affect effluent water quality and how much water (plant |
| | | effluent water) might be needed for a process. |
| Environmental | Energy | Energy conserved from energy improvements, option |
| | conservation | or project. |
| Monetary | Cost Effectiveness | Net Project Costs (Capital, O&M) and Carbon |
| | | Reduction over project life |
| Monetary | Benefit-Cost Ratio | The relative cost of a project or option compared to |
| | | benefits achieved. |
| Monetary | Annual Operation | Net O&M Cost over project life |
| | Cost | |
| Monetary | Implementation | Net Capital Cost over project life |
| | Cost | |
| Monetary | Life-Cycle Cost | This criterion reflects a total cost of a project |
| | | considered over a planning period, considering upfront |
| | | capital costs, annual operating costs, annual |
| | | maintenance costs, potential revenues or offsets from |
| | | resource recovery, periodic refurbishments, periodic |
| | | replacements, and a salvage value measured at the end |
| | | of the twentieth year. |
| Monetary | Cost Risk/Liability | This criterion measures exposure of estimated capital |
| | | and annual costs to unforeseen circumstances or |
| | | changes in key assumptions and inputs pricing. Risk |
| | | factors may include construction cost overruns, fossil |
| | | fuels prices, chemical prices, electric power prices, |
| | | GHG emissions prices and other factors outside a |
| | | jurisdiction's control. |

TABLE 1B
Example criteria that can be analyzed in a framework

| Overall | | |
|---|---|---|
| Allocation | Criterion | Metrics/Details |
| Monetary | End of Use | This criterion measures reliability of an end use outlet (e.g., |
| | Management and | how likely is it that the final use outlet will be available |
| | Control | during a project life), as well as an ability to control/mitigate |
| | | and respond to off-site problems (e.g., “bad load” applied, |
| | | odor incident in field, hauling problems off-site). |
| Monetary | Flexibility | This criterion addresses flexibility with respect to |
| | | implementation (construction phasing), expansion potential, |
| | | and diversification potential for outlets. Greater product |
| | | flexibility may mean there are multiple different final use |
| | | outlets (based on availability and cost) that can be accessed |
| | | with little or no impact on equipment or operations. |
| Monetary | Ease of O&M | This criterion focuses on a broad range of O&M issues, |
| | and Safety | including complexity, potential training needs, and safety. |
| | | The criterion considers that complex systems may generally |
| | | be more susceptible to downtime than less complex systems, |
| | | which impacts reliability, and may have additional |
| | | maintenance requirements as well. Complexity also impacts |
| | | a skill level required for O&M staff, and most likely require |
| | | more training. This criterion also considers a level of |
| | | operational safety provided by a system. |
| Monetary | Reliability | Reliability is an ability to effectively monitor, assess, predict, |
| | | and generally understand the working of an initiative and its |
| | | assets and successfully deploy a cost-effective and optimal |
| | | maintenance strategy. Reliable functioning allows routine |
| | | and predictive maintenance to be identified, dominant failure |
| | | modes to be ascertained, and consequences of failure to be |
| | | estimated with a degree of confidence. |
| Monetary | Constructability | This criterion measures both an ability to construct an |
| | | initiative without undue capital cost risk, as well as physical |
| | | limitations that might presented with respect to site |
| | | constraints and/or existing facilities. |
| Monetary | Impacts on Plant | This criterion addresses flexibility with respect to |
| | Processes and | implementation (construction phasing), expansion potential, |
| | Facilities | and diversification potential for outlets. Greater product |
| | | flexibility may mean there are multiple different final use |
| | | outlets (based on availability and cost) that can be accessed |
| | | with little or no impact on equipment or operations. |
| Monetary | Regulatory | This criterion deals with difficulty and timeframe needed to |
| | Permitting | permit a technology. |

TABLE 1C
Example criteria that can be analyzed in a framework

| Overall | | |
|---|---|---|
| Allocation | Criterion | Metrics/Details |
| Social | Community safety | Anticipated impact to community public safety. |
| Social | Impacts on | Anticipated to negatively or positively impact |
| | transportation | community access to public transport, and likely |
| | accessibility (public | degree of impact. |
| | transportation) | |
| Social | Environmental | Impact upon established Disadvantaged Communities |
| | justice | (DACs) (e.g., minority/low income/underserved |
| | considerations | communities) in accordance with Justice 40. |
| Social | Job/employment | Anticipated number of jobs created by |
| | creation | implementation of an initiative in an area of interest |
| | | (e.g., local, regional, state). |
| Social | Air quality | Net change in NOx, VOCs (e.g., ozone precursors), |
| | improvement to | and sulfur dioxide (SO2) emissions in relevant non- |
| | community | attainment jurisdictions. |
| | multiscale air quality | |
| | (CMAQ) non- | |
| | attainment areas | |
| Social | Noise pollution | Extent a project or option may impact households |
| | impacts | through increased noise emissions. |
| Social | Disruption to basic | Disruption to basic community resources (grocery |
| | community resources | stores, public transportation, public assistance |
| | | programs, schools, city centers). Consideration of |
| | | how a project or option might impact access to basic |
| | | community resources throughout the project (even if |
| | | it is temporary). |
| Social | Impact to culturally | Determining if there will be any |
| | significant sites and | displacement/disruption/destruction of sites that hold |
| | practices | cultural or community significance. Additionally |
| | | understanding if there are any cultural barriers to |
| | | implementation or acceptance of a project. |

TBL criteria applicable to an industry and analysis may be presented to a user for selection and, while a broad variety of criteria may improve robustness of a TBL analysis, an analysis may at least have a minimum of two criteria. In the TBL assessment 140, some criteria may be evaluated quantitatively while others may be evaluated qualitatively.

A process of the TBL assessment 140 may include an analysis of an initiative and benefits and disbenefits each criterion provides for a user. Such an analysis may require a detailed methodology for each initiative, allowing for a thoughtful and descriptive explanation for stakeholders and users to look over and ensure that a common sustainable goal is being maintained. An example methodology that may be developed and used in the step 102d is presented below. The following may be an example TBL criteria evaluation methodology utilized to calculate values for carbon emissions and CAP emissions of one option or initiative e.g., using bike and pedestrian (ped) infrastructure:
a) Carbon Emissions—Methodology:
   i. Identified mode share shift prediction from installation of safe and efficient bike/ped in urban areas. One additional mile of Class II bike lanes per square mile is associated with a roughly 1 percent increase in a share of workers commuting by bicycle in cities with population of more than 250,000.
   ii. Applied a mode share shift to commuting passenger car Vehicle Miles of Travel (VMT) for Cleveland, Columbus, Cincinnati, and Toledo normalized for a land area of the cities. 91 percent of total VMT is deemed passenger vehicle VMT per 2020 baseline data. 28 percent of annual passenger vehicle VMT is deemed to be commuting.
   iii. The emission factor for internal combustion engine (ICE) vehicles is 352 grams per carbon dioxide equivalents per VMT (g CO₂e/VMT) and represents a weighted average of three Ohio counties (Cuyahoga, Franklin, and Hamilton) with a highest VMT in year 2020 (baseline year) for passenger cars only.
   iv. Final unit: metric tons (MT) CO₂e reduced/year/1 mile bike/ped installed/square mile.
b) CAPs Emissions—Methodology:
   i. Approach for CAPs is the same as carbon emissions. However, emission factors used will be different. Emission factors for ICE vehicles for CAPs represents a weighted average of three Ohio counties (Cuyahoga, Franklin, and Hamilton) with the highest VMT in year 2020 (baseline year) for passenger cars only. Total CAPs is considered a sum of NOₓ, PM_{2.5}, and VOCs. Emission factors for these CAPs are as follows:
      1) NOₓ: 0.199 g/VMT
      2) PM_{2.5}: 0.009 g/VMT
      3) VOCs: 0.289 g/VMT
   ii. Final unit: Pounds (lbs) total CAPs reduced/year/1 mile bike/ped installed/square mile.

The framework 100 may allow for a multi-scenario analysis outcome to enhance results of the TBL assessment 140, wherein multiple scenarios can be examined, and outputs calculated to ensure that maximum data accuracy may be obtained. Multiple scenarios can also assist in developing a more detailed implementation phase 134 for a user.

### Exemplary Step: Multi-Criteria Decision Analysis

Results of the TBL assessment 140 may then be used in the step 102e as input in a Multi-Criteria Decision Analysis (MCDA) tool 150 with criteria weighted based on user and/or stakeholder input as shown in FIG. 1 and in Table 2 below. A weighting may be established prior to the step 102e.

TABLE 2
Example weighting of TBL criteria

| | Overall | | Proportional |
|---|---|---|---|
| Rank | Criteria | TBL Criterion | Weighting |
| 1 | Monetary | Cost effectiveness | 17% |
| 2 | Environmental | Carbon reductions | 15% |
| 3 | Monetary | Implementation costs | 12% |
| 4 | Monetary | Annual operation costs | 11% |
| 5 | Social | Community safety | 10% |
| 6 | Environmental | Climate resiliency opportunities (or co-benefits) | 8% |
| 7 | Social | Impacts to public transportation accessibility | 8% |
| 8 | Social | Environmental justice considerations | 8% |
| 9 | Social | State-based job/employment creation | 4% |
| 10 | Environmental | Land use burden | 3% |
| 11 | Environmental | CAP emission reductions | 2% |
| 12 | Social | Air quality improvement to CMAQ non-attainment | 2% |
| | | areas | |

The MCDA tool 150 may rank initiatives regarding their overall sustainability utilizing the calculations derived in the step 102d to compare initiatives. For example, Initiative A may result in 50 MT of CO₂e/year, whereas Initiative B may result in 100 MT, or Initiative A may burden 1,000 acres whereas Initiative B may burden 500 acres. These values from the step 102d may be entered into the MCDA tool 150.

The MCDA 150 may be completed using a sophisticated, multi-criteria evaluation program called EVAluation of MIXed data (EVAMIX). EVAMIX is a tool to build a pair-wise comparison approach that appropriately compares mixed data (e.g., qualitative and quantitative). EVAMIX is designed to make use of both concordance/discordance analysis and a goals-achievement matrix approach to handle mixed data in a rigorous fashion regardless of units of measure. A method for EVAMIX that may be used in embodiments is described in Byun, et al., “Overcoming obstacles in applying SWMM to large-scale watersheds,” Journal of Water Management Modeling (2003), which is herein incorporated by reference in its entirety.

Concordance/discordance analysis is a pair-wise comparison approach that seeks to avoid numerical problems of comparing units of measure and mixed data. A matrix approach using EVAMIX may allow for evaluation of initiative plans, sites, and/or technologies with an objective of selecting the best one or ranking initiatives for presentation to decision makers.

The method behind EVAMIX maintains characteristics of quantitative and qualitative criteria, yet is designed to combine the results in a single appraisal score. This unique feature gives a program much greater flexibility than most other matrix-based evaluation programs and may allow for use of all data its original form. In a first step, an evaluation matrix is split into two sub-matrices, one with only cardinal criteria, and one with only ordinal criteria. Cardinal data may be defined as quantitative data that EVAMIX utilizes. Ordinal data may be defined as qualitative data that EVAMIX utilizes.

The choice of whether to define a criterion as quantitative or qualitative may depend on a feasibility of describing an impact with numbers, an availability of data to assign scores to each option, and/or a reliability of the data. For example, under environmental criteria, land use burden can be utilized with quantitative values where specific projects are known.

If gaining comparative hard data is unachievable, or the data are unreliable, it may not be appropriate to assign a quantitative number to a particular option. The criteria then can be adjusted to a qualitative status.

A next task in an evaluation procedure may include selection of weighting factors for each of the criteria.

As illustrated in FIG. 1, an input to the step 102e may include criteria setting and weighting 122. The input 122 may be intended to inform weightings applied to each criterion in the MCDA tool 150. Each criterion score may be translated into a proportional weighting. An example of this can be seen in Table 2 above.

Using scores and weights, dominance scores “a” and “A”, for ordinal and cardinal data respectively, may be calculated. A dominance score may be a number that represents a degree to which initiative A dominates initiative B. A dominance score may be calculated for each potential pair of initiatives for each criterion. For cardinal criteria, a difference in values assigned to each initiative may be preserved in equations. Thus, a dominance score for initiative A over B may be much higher if A is significantly better than B but may be small if the two score almost equal for that criterion.

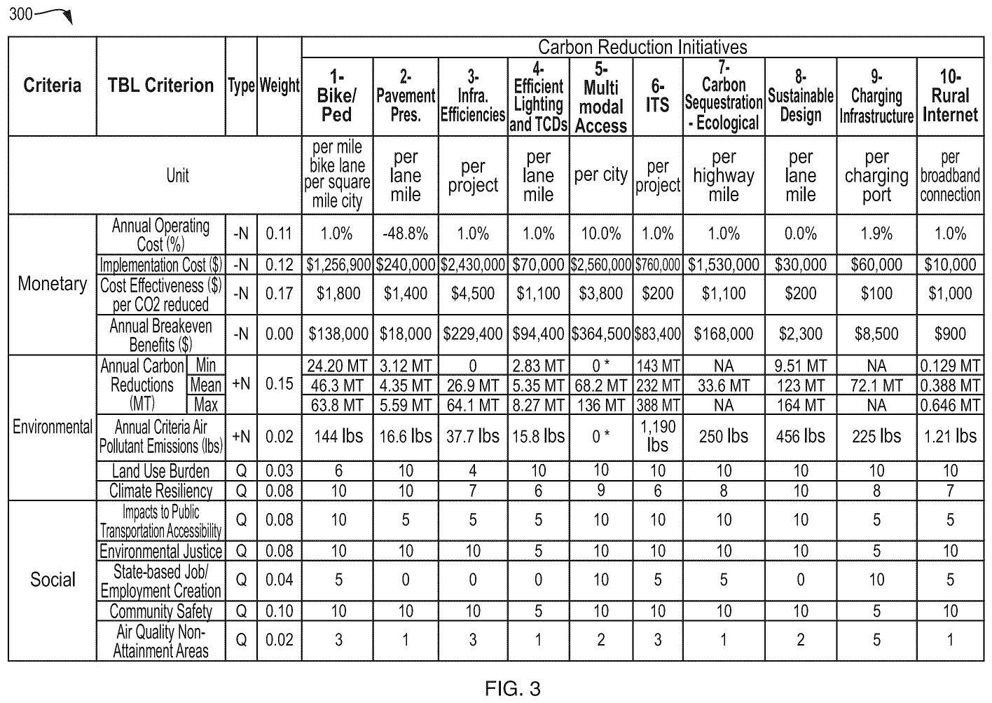

FIG. 3 is a table 300 of exemplary values for criterion-option pairs used in the MCDA 150 according to an example embodiment. The table 300 may identify example input values for each option and criteria, differentiating between qualitative (Q), numerical positive (+N), and numerical negative (−N) (these may be derived in the step 102d).

Tables 3-5 below present exemplary results of an EVAMIX ranking, illustrating how EVAMIX calculates appraisal scores using two different techniques, and results in a ranking of options, as well as showcases the framework 100's ability to apply an analysis to multiple scenarios.

TABLE 3
Example MCDA Results and Rankings - Scenario
1 Minimum Carbon Emission Reduction Values

| Carbon Reduction Initiative | Appraisal #1 | Appraisal #2 | Rank #1 | Rank #2 |
|---|---|---|---|---|
| 6-Intelligent Transportation Systems (ITS) | 0.0097 | 0.1724 | 1 | 1 |
| 8-Sustainable Design | 0.0078 | 0.1410 | 2 | 2 |
| 1-Bike/Ped Infrastructure | 0.0062 | 0.1219 | 3 | 3 |
| 2-Pavement Preservation | 0.0037 | 0.0634 | 4 | 4 |
| 7-Carbon Sequestration - Ecological | 0.0005 | 0.0018 | 5 | 5 |
| 10-Promote Rural Internet Connectivity | −0.0001 | −0.0020 | 6 | 6 |
| 9-Charging Infrastructure | −0.0031 | −0.0691 | 7 | 7 |
| 5-Multimodal Access | −0.0058 | −0.1184 | 8 | 8 |
| 4-Energy-efficient Lighting and Traffic | −0.0081 | −0.1237 | 9 | 9 |
| Control Devices (TCDs) | | | | |
| 3-Prioritize Infrastructure Efficiencies | −0.0109 | −0.1872 | 10 | 10 |

TABLE 4
Example MCDA Results and Rankings - Scenario
2 Mean Carbon Emission Reduction Values

| Carbon Reduction Initiative | Appraisal #1 | Appraisal #2 | Rank #1 | Rank #2 |
|---|---|---|---|---|
| 8-Sustainable Design | 0.0095 | 0.1583 | 1 | 1 |
| 6-Intelligent Transportation Systems | 0.0086 | 0.1413 | 2 | 2 |
| 1-Bike/Ped Infrastructure | 0.0029 | 0.0516 | 3 | 3 |
| 7-Carbon Sequestration - Ecological | 0.0016 | 0.0297 | 4 | 4 |
| 2-Pavement Preservation | 0.0012 | 0.0206 | 5 | 5 |
| 10-Promote Rural Internet Connectivity | −0.0001 | −0.0028 | 6 | 6 |
| 9-Charging Infrastructure | −0.0002 | −0.0078 | 7 | 7 |
| 5-Multimodal Access | −0.0058 | −0.0888 | 8 | 8 |
| 4-Energy-efficient Lighting and TCDs | −0.0078 | −0.1359 | 9 | 9 |
| 3-Prioritize Infrastructure Efficiencies | −0.0101 | −0.1662 | 10 | 10 |

TABLE 5
Example MCDA Results and Rankings - Scenario
3 Maximum Carbon Emission Reduction Values

| Carbon Reduction Initiative | Appraisal #1 | Appraisal #2 | Rank #1 | Rank #2 |
|---|---|---|---|---|
| 8-Sustainable Design | 0.0101 | 0.1874 | 1 | 1 |
| 6-Intelligent Transportation Systems | 0.0074 | 0.1395 | 2 | 2 |
| 1-Bike/Ped Infrastructure | 0.0034 | 0.0707 | 3 | 3 |
| 2-Pavement Preservation | 0.0009 | 0.0120 | 4 | 4 |
| 7-Carbon Sequestration - Ecological | 0.0010 | 0.0199 | 5 | 5 |
| 10-Promote Rural Internet Connectivity | −0.0012 | −0.0330 | 6 | 6 |
| 9-Charging Infrastructure | −0.0030 | −0.0751 | 7 | 7 |
| 5-Multimodal Access | −0.0034 | −0.0323 | 8 | 8 |
| 4-Energy-efficient Lighting and TCDs | −0.0064 | −0.1365 | 9 | 9 |
| 3-Prioritize Infrastructure Efficiencies | −0.0068 | −0.1128 | 10 | 10 |

Tables 3-5 above are examples of MCDA tool outputs ranking sustainability of options based on criteria, weightings, and/or the TBL assessment 140 output values. Further, Tables 3-5 above illustrate the framework 100's versatility in analyzing multiple scenarios for a proposed initiative.

Continuing with FIG. 1, the step 102e may include a sensitivity analysis 160. The sensitivity analysis 160 may be used to understand uncertainty in analysis results. Sensitivity testing findings from the MCDA 150 can be used to understand sensitivity of initiative groupings and/or the TBL criteria weightings 122. In turn, this can improve robustness of the framework 100 findings and better inform decision-making. The sensitivity analysis 160 can be completed by either repeating the MCDA 150 and appraisal step by adjusting criteria weightings that were determined prior to the step 102e, or running, e.g., a Monte Carlo simulation for a set of probabilistic results. The sensitivity analysis 160 can be applied to multiple scenarios to determine if there need to be any adjustments in criteria weightings. The results may be clearly documented and presented to a user, as they can inform final selection of initiatives to carry forward into the implementation phase 134.

The sensitivity testing component 160 may formalize sensitivity testing as a component of the MCDA step 150. The MCDA 150 and associated sensitivity analysis 160 may be provided via, e.g., a web-based tool and/or may leverage computational simulation, e.g., Monte Carlo simulation, stochastic simulation, etc.

### Additional Optional Components

The framework 100 may include three optional components that are available to be implemented within constraints of each project:
a) Stakeholder Consultation and Input 104—The optional stakeholder consultation 104 may start early in a methodology and may be tailored to project specifics, user expectations, and/or need. At a basic level, stakeholders for a project may only be user staff, whereas for other projects stakeholders may include various external parties or community groups. Outreach strategies for each of these stakeholders may be defined in an analysis (refer to the step 102a). An example of this outreach may include facilitation of an internal or external steering committee, facilitation of regional meetings, and/or development of website, social media, and/or survey content. The optional stakeholder consultation component 104 may formalize one or more points where early and frequent stakeholder consultation may be recommended for successful use of the framework 100.
   i. The framework 100 may identify four example stages for the optional stakeholder involvement 104:
      1) Upfront when establishing the system boundary conditions 110 (optional input 124a from stakeholders);
      2) When establishing the existing conditions 120 and screening criteria 114c (optional input 124b from stakeholders);
      3) Results of the filter/screen analysis 130 (optional output 126a to stakeholders); and/or
      4) The MCDA 150 with optional input 124c for setting the criteria and weightings 122 and then results/findings being an optional output 126b to stakeholders.
   ii. Early identification of stakeholders relevant to an analysis and stages of their involvement can be valuable to successfully completing an analysis via the framework 100. The optional component 104 may make early stakeholder consultation a clear recommendation of a methodology, and may identify stages at which this should occur for clarity and/or ease of use.
b) Sustainable Initiatives Uncertainty 106—The optional uncertainty scale component 106 may promote the framework 100 users to consciously analyze, document, and/or communicate a level of uncertainty—e.g., higher 132 or lower 128—in options that are being considered and analyzed in the framework 100. The optional component 106 may include three example stages in the framework 100 that reduce uncertainty:
   1) When stakeholder values are established;
   2) Once the filter/screen process 130 is complete; and
   3) Once the MCDA 150 is finalized. A level of uncertainty may be tracked and/or communicated to a user, particularly if the user chooses to skip steps in the framework 100.
   ii. It can be valuable understanding and communicating uncertainty in sustainable initiatives evaluation throughout a process. At a beginning of an analysis, there may be the higher uncertainty 132 regarding suitability of initiatives. Some may seem suitable on face value, but how do they stack up when considering a TBL? In addition, complex modeling with underlying assumptions may have a level of uncertainty that can be presented as a range of values or standard deviation as an added value component to inform shareholder decision making.
c) Feedback Loop for Continuous Improvement 108—The optional continuous improvement component 108 may introduce a feedback loop as outcomes of the framework 100 are implemented and new data is collected. The framework 100 may promote ongoing review of outcomes (e.g., selected and implemented GHG reduction initiatives) alongside performance metric monitoring data to conduct confirmation analysis accuracy, actual impact, and/or achievement of goals/targets.
   i. For the sustainability initiatives 114a to be successful, the optional feedback loop 108, which integrates evolving data (e.g., monitoring data, regulatory/policy updates, technology advances and market availability, available funding, and/or stakeholder values), can be valuable to monitor achievement towards goals/targets and/or inform adaptive management of actions to successfully meet them. The optional feedback loop 108 can also be valuable for continuous improvement (particularly International Organization for Standardization (ISO) certified companies), ongoing reporting obligations (can be internal or external), and/or for reanalysis.

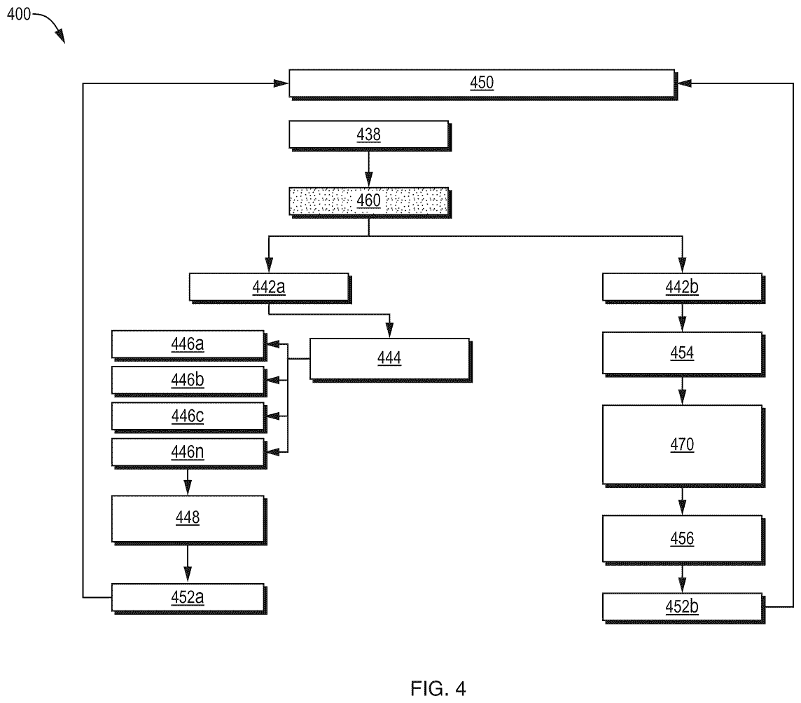

FIG. 4 is a flow diagram of a process 400 for sensitivity testing according to an example embodiment. In the process 400, MCDA results 438 may be received as input. In an example embodiment, the MCDA results 438 may be results of the MCDA tool 150 (FIG. 1) utilizing an EVAMIX tool and the criteria weightings 122 (FIG. 1). A sensitivity analysis 460 may be performed using the MCDA results 438. In another example embodiment, it may determined whether to perform the sensitivity analysis 460 according to example option 442a, for a manual process, or example option 442b, for probabilistic modeling (e.g., via a Monte Carlo simulation).

In an example embodiment, the manual option 442a may include obtaining inputs of altered weightings 444. According to another example embodiment, the alternative weightings 444 may be selected to assign to criteria used as a basis for MCDA, e.g., the MCDA 150. In yet another example embodiment, the altered weightings 444 may account for significant adjustments of weighting across three overarching areas of TBL criteria—monetary, environmental, and social. In an example embodiment, a number of scenarios 446a-446n may not be fixed and may instead vary based on, e.g., plausible alternative weightings.

According to an example embodiment, using the manual option 442a, results 448 of each alternative weighting scenario 446a-446n may be analyzed, graphed, and/or recorded (i.e., documented). In another example embodiment, changes in sustainability initiative scores and/or rankings may indicate uncertainty. According to yet another example embodiment, based on a number changes and/or degree of change, uncertainty in the results 448 may be qualified.

In an example embodiment, the documented results 448 of the manual sensitivity analysis 442a may be compiled 452a with the original MCDA results 438. According to another example embodiment, depending on a level of change experienced in an analysis, it may be determined to undertake further sensitivity testing 460, alter initiative rankings from the original MCDA results 438, and/or carry forward with the original rankings 438.

According to example embodiment, in the modeled approach 442b, data and/or variables 454 may be collated for initiatives considered in the MCDA 438. In another example embodiment, uncertain variables in the input data 454 and/or weightings may be selected. According to yet another example embodiment, a Monte Carlo or similar stochastic simulation 470 may be used to produce a probabilistic spread of results 456. The output distribution 456 may provide the most probable estimates.

In an example embodiment, documented results 456 of the modeled sensitivity analysis 442b may be compiled 452b with the original MCDA results 438. These may include a distribution. Similar to the manual process 442a, it may be determined to undertake further sensitivity testing 460, alter initiative rankings from the original MCDA results 438, and/or carry forward with the original rankings 438.

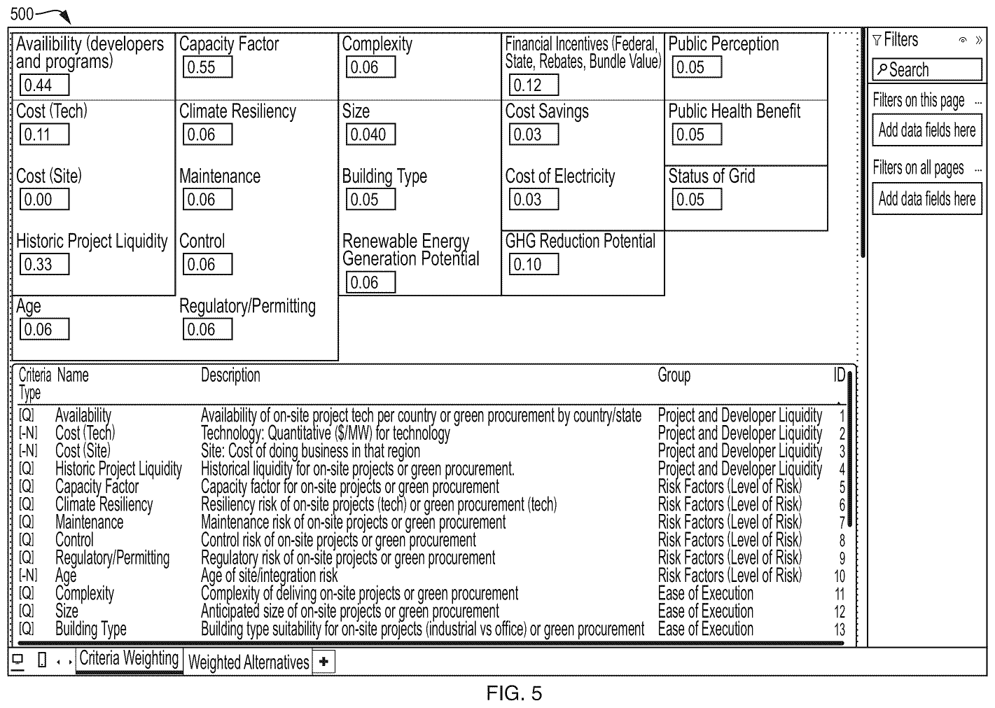

FIG. 5 is an image of a sample MCDA dashboard 500 according to an example embodiment. In an example embodiment, the sample MCDA dashboard 500 may be a Power BI® dashboard for ease of use; other known dashboard types are also suitable.

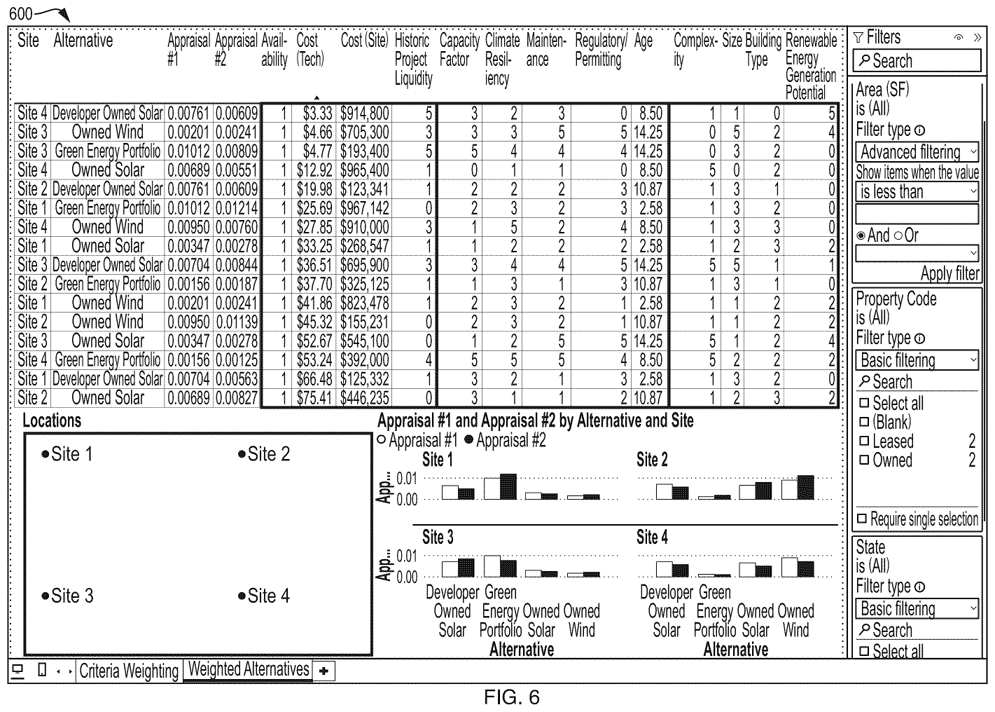

FIG. 6 is an image of a sample MCDA dashboard 600 according to another example embodiment. In an example embodiment, the sample MCDA dashboard 600 may be a Power BI dashboard for ease of use; other known dashboard types are also suitable.

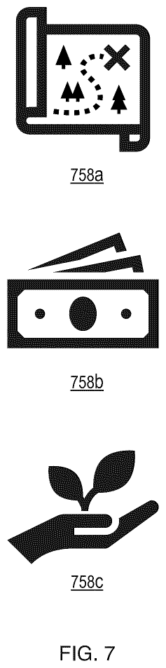

FIG. 7 is a block diagram of exemplary selection criteria 758a-758c according to an example embodiment. In an example embodiment, the exemplary criteria 758a-758c may relate to ability to implement, cost efficacy, and environmental benefits, respectively, and may be used to identify and/or evaluate carbon reduction initiatives and/or strategies generated in, e.g., the transportation sector. According to another example embodiment, identifying and/or evaluating initiatives and/or strategies may include analyzing system use, capital projects, and/or O&M, among other examples. In yet another example embodiment, selection may be based on stakeholder engagement.

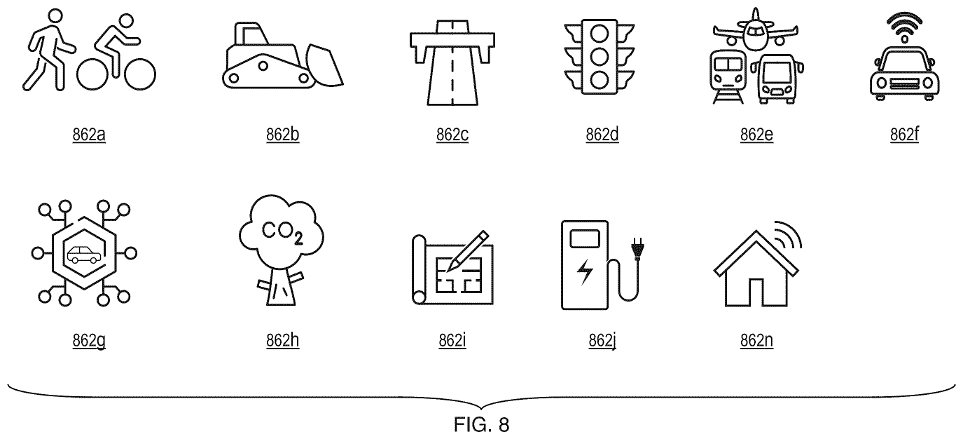

FIG. 8 is a block diagram of exemplary initiatives 862a-862n according to an example embodiment. In an example embodiment, the exemplary initiatives 862a-862n may be carbon reduction initiatives, and may relate to bike and pedestrian infrastructure, regular maintenance, prioritizing infrastructure efficiencies, energy-efficient lighting and TCDs, multimodal access, connected and autonomous vehicles, intelligent transportation systems, carbon sequestration and ecological factors, sustainable design, charging infrastructure, and promoting rural internet connectivity, respectively.

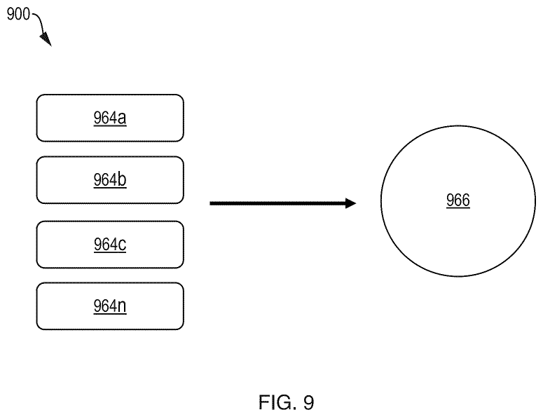

FIG. 9 is an overview diagram of a carbon reduction calculator 900 according to an example embodiment. In an example embodiment, as shown in FIG. 9, the calculator 900 may obtain one or more input(s) 964a-964n. According to another example embodiment, the calculator 900 may produce output 966, e.g., carbon reduction potential. In yet another example embodiment, a user may employ the calculator 900 to calculate potential reduction in carbon and/or CAP emissions for, e.g., multiple transportation initiatives.

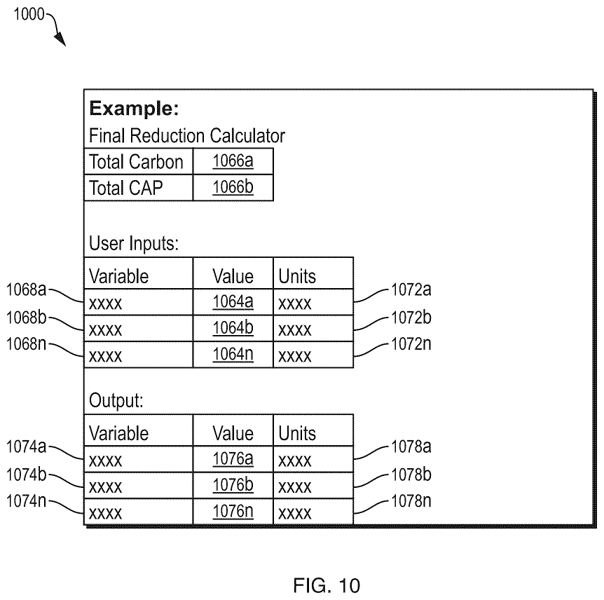

FIG. 10 is a user interface for a carbon reduction calculator 1000 according to an example embodiment. In an example embodiment, as shown in FIG. 10, a user may enter or insert value(s) 1064a-1064n for corresponding variable row(s) 1068a-1068n. According to another example embodiment, measures may be taken to ensure that the entered values 1064a-1064n match corresponding units 1072a-1072n. In yet another example embodiment, the carbon reduction calculator 1000 may use the input values 1064a-1064n to calculate final emission reduction potential values 1066a-1066b. According to an example embodiment, the carbon reduction calculator 1000 may also produce additional output values 1074a-1074n for output variables 1076a-1076n with corresponding units 1078a-1078n.

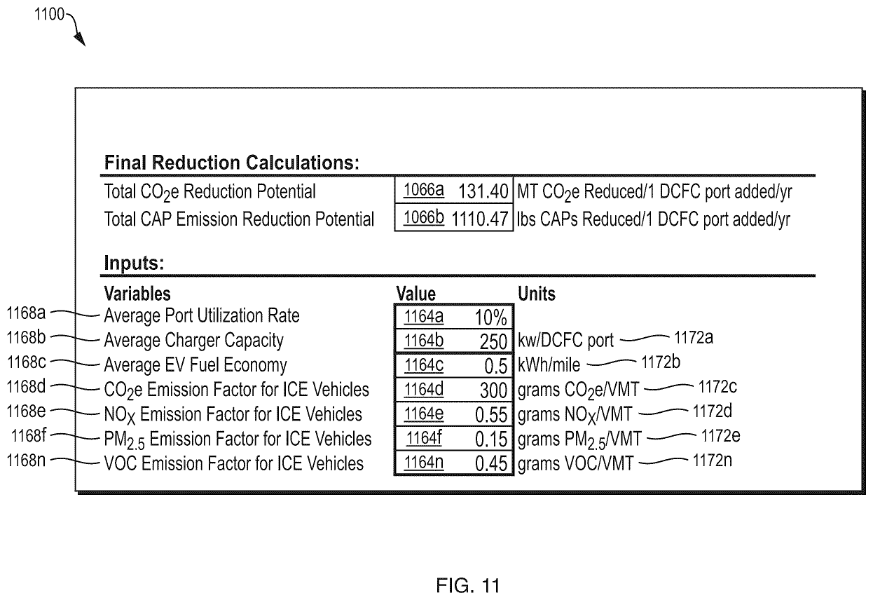

FIG. 11 is a user interface for an emissions calculator 1100 according to an example embodiment. In an example embodiment, the emissions calculator 1100 may be used as part of evaluating, e.g., a charging infrastructure initiative, and may analyze, for non-limiting examples: charger types; charging infrastructure metrics such as average port utilization rate, charger capacity, and/or daily energy expenditure; and/or annual ICE VMT displaced. According to another example embodiment, the emissions calculator 1100 may be a GHG and CAP emission calculator for a direct current fast charger (DCFC) infrastructure initiative. In yet another example embodiment, as shown in FIG. 11, the emissions calculator 1100 may take as inputs user-entered exemplary values 1164a-1164n for variables 1168a-1168n, with corresponding units 1172a-1172n for variables 1168b-1168n (i.e., the variable 1168a may be unitless). According to an example embodiment, the emissions calculator 1100 may use the input values 1164a-1164n to calculate final emission reduction potential values 1166a-1166b.

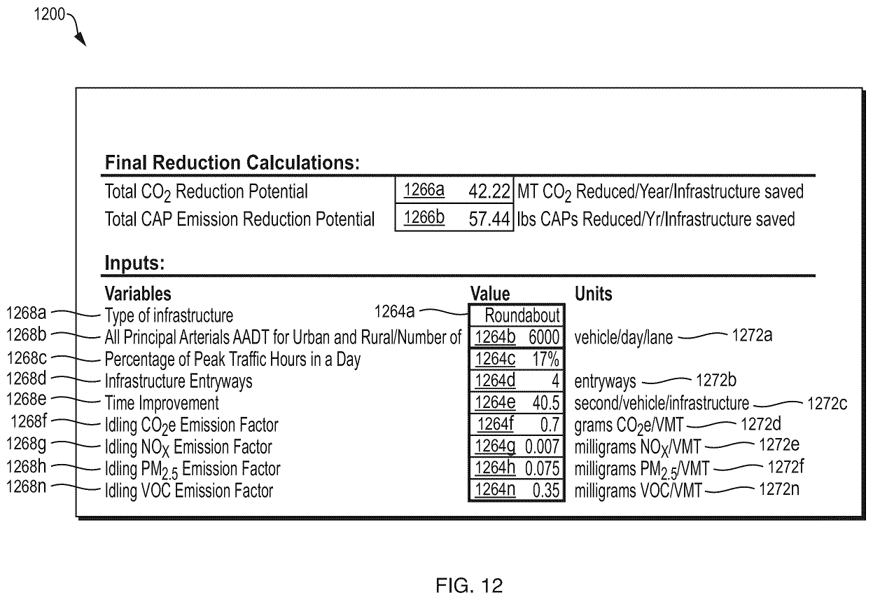

FIG. 12 is a user interface for an emissions calculator 1200 according to another example embodiment. In an example embodiment, the emissions calculator 1200 may be used as part of evaluating, e.g., a transportation infrastructure initiative related to roundabouts (or similar infrastructure such as rotaries or traffic circles), and may analyze, for non-limiting examples: a resource review; transportation infrastructure metrics such as time improvement, average annual daily traffic (AADT), idling emission factors, and/or number of entryways; and/or annual idling emissions displaced. According to another example embodiment, the emissions calculator 1200 may be a GHG and CAP emission calculator for an initiative to prioritize transportation infrastructure efficiencies. In yet another example embodiment, as shown in FIG. 12, the emissions calculator 1200 may take as inputs user-entered exemplary values 1264a-1264n for variables 1268a-1268n, with corresponding units 1272a-1272n for variables 1268b-1268n (i.e., the variables 1268a and 1268c may be unitless). According to an example embodiment, the emissions calculator 1200 may use the input values 1264a-1264n to calculate final emission reduction potential values 1266a-1266b.

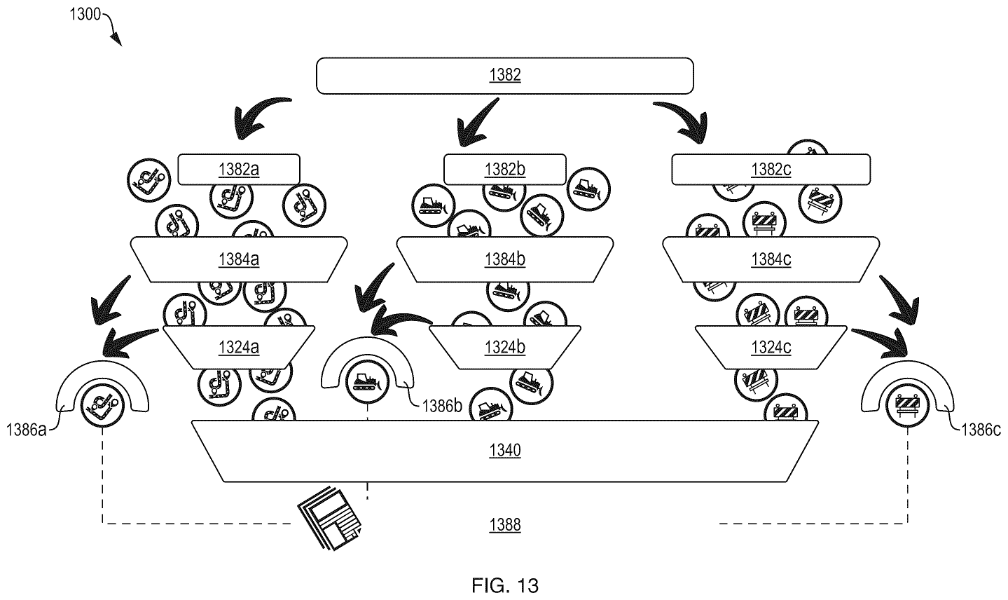

FIG. 13 is a flowchart of a method 1300 for creating a carbon reduction roadmap according to an example embodiment. In an example embodiment, the method 1300 may be implemented using a sustainability analytics framework, e.g., the framework 100 (FIG. 1). According to another example embodiment, the method 1300 may be used to create a carbon reduction roadmap for a transportation system. First, as shown in FIG. 13, the method 1300 may begin with uncategorized carbon reduction initiatives 1382. The method 1300 may then categorize the initiatives 1382 into system use 1382a initiatives, capital projects 1382b initiatives, and O&M (e.g., of facilities, vehicle fleets, and infrastructure) 1382c initiatives. In turn, the method 1300 may conduct a fatal flaw analysis 1384a, 1384b, and 1384c on the initiatives 1382a, 1382b, and 1382c, respectively, to evaluate whether each set of initiatives produces required and/or desired results. The method 1300 may further screen the initiatives 1382a, 1382b, and 1382c based on stakeholder input 1324a, 1324b, and 1324c, respectively. In yet another example embodiment, the stakeholder input 1324a-1324c may include using a collaborative selection process developed with a diverse group of stakeholders, to identify preferred carbon reduction strategies. To continue, the fatal flaw analysis 1384a, 1384b, and 1384c and/or the stakeholder input 1324a, 1324b, and 1324c may result in certain of the initiatives 1382a, 1382b, and 1382c being designated as non-priority strategies 1386a, 1386b, and 1386c, respectively. The method 1300 may perform a TBL assessment 1340 on the remaining initiatives 1382a, 1382b, and 1382c (optionally including the non-priority strategies 1386a, 1386b, and 1386c as well) to generate a final carbon reduction roadmap or strategy for implementation and reporting. In an example embodiment, the TBL assessment 1340 may be a detailed TBL analysis of, e.g., the top 10 carbon reduction initiatives.

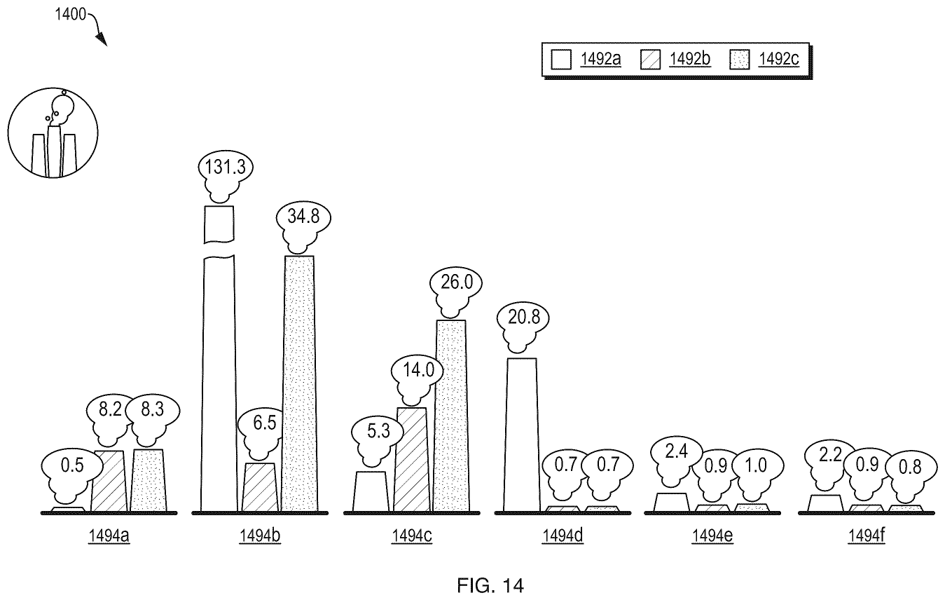

FIG. 14 is a bar graph 1400 of pollutants emissions according to an example embodiment. In an example embodiment, the graph 1400 may be generated by using a sustainability analytics framework, e.g., the framework 100 (FIG. 1), to analyze data points including the following non-limiting examples:
a) GHG lifecycle emissions;
b) CAPs and hazardous air pollutants;
c) Social costs of emissions;
d) Environmental justice considerations;
e) Human health risk assessment screening;
f) Ecological screening of air emissions;
g) Power generation;
h) Hauling and disposal cost;
i) Vehicle collisions; and/or
j) Alignment with user sustainability goals.

According to another example embodiment, the graph 1400 may reflect a TBL assessment of a waste-to-energy scenario 1492a versus two different landfill scenarios 1492b and 1492c for solid waste processing. In yet another example embodiment, the graph 1400 may illustrate a 20-year annual average of tons per year for CAPs emissions including VOC 1494a, NOX 1494b, CO 1494c, SO2 1494d, PM10 1494e, and PM2.5 1494f. As shown in FIG. 14: the VOC 1494a may be 0.5, 8.2, and 8.3 respectively for the scenarios 1492a, 1492b, and 1492c; the NOX 1494b may be 131.3, 6.5, and 34.8, respectively for the scenarios 1492a, 1492b, and 1492c; the CO 1494c may be 5.3, 14.0, and 26.0 respectively for the scenarios 1492a, 1492b, and 1492c; the SO2 1494d may be 20.8, 0.7, and 0.7 respectively for the scenarios 1492a, 1492b, and 1492c; the PM10 1494e may be 2.4, 0.9, and 1.0 respectively for the scenarios 1492a, 1492b, and 1492c; and the PM2 1494f may be 2.2, 0.9, and 0.8 respectively for the scenarios 1492a, 1492b, and 1492c. Further, lead (Pb) emissions (not shown) may be 0.0021, 0.0, and 0.0 for the scenarios 1492a, 1492b, and 1492c, respectively. According to an example embodiment, an analysis generated via the framework 100—including the graph 1400—can help a user make informed decisions toward meeting sustainability and/or climate goals.

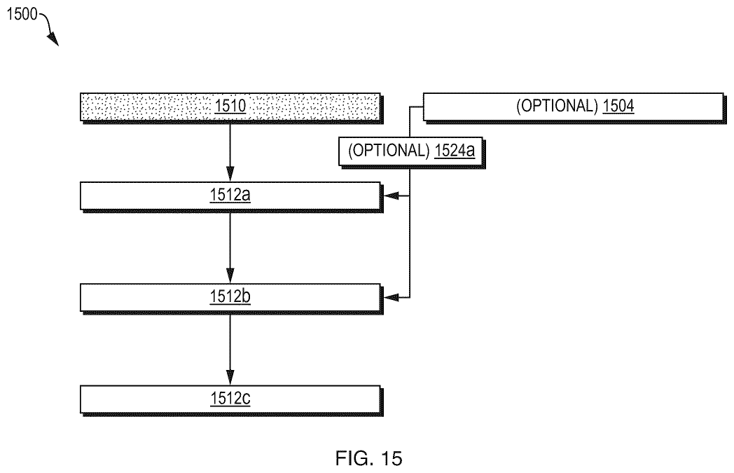

FIG. 15 is a flow diagram of a process 1500 for determining a system boundary according to an example embodiment. In an example embodiment, the process 1500 may include a component 1510 for determining a system boundary. According to another example embodiment, the component 1510 may first establish objectives of an analysis 1512a with, e.g., a team, initiative proponent, and/or user. Establishing the objectives 1512a may receive optional input 1524a from stakeholder(s) 1504, whether limited to internal or including external. These objectives 1512a may be different from sustainability or GHG reduction goals and may address what an operator seeks to achieve by utilizing a framework, e.g., the framework 100 (FIG. 1).

According to an example embodiment, the component 1510 may in turn define the scale and bounds of an analysis 1512b. This component 1512b may include specific industries and/or sectors an analysis may be limited to as well as a geographic and/or temporal scale of a study (e.g., spatially limited to a region or state and/or temporally focused on short-term or long-term initiatives). Again, this may be driven by the optional input 1524a from the stakeholder(s) 1504, whether internal and/or external.

In an example embodiment, the component 1510 may then, where scope allows, define outreach strategies for stakeholder(s) 1512c. This may account for the importance of stakeholder input in successful implementation of a framework, e.g., the framework 100, and sustainability analysis in general. An example of this outreach 1512c may include, e.g., facilitation of an internal or external steering committee, facilitation of regional meetings, and/or development of a website, social media, and/or survey content.

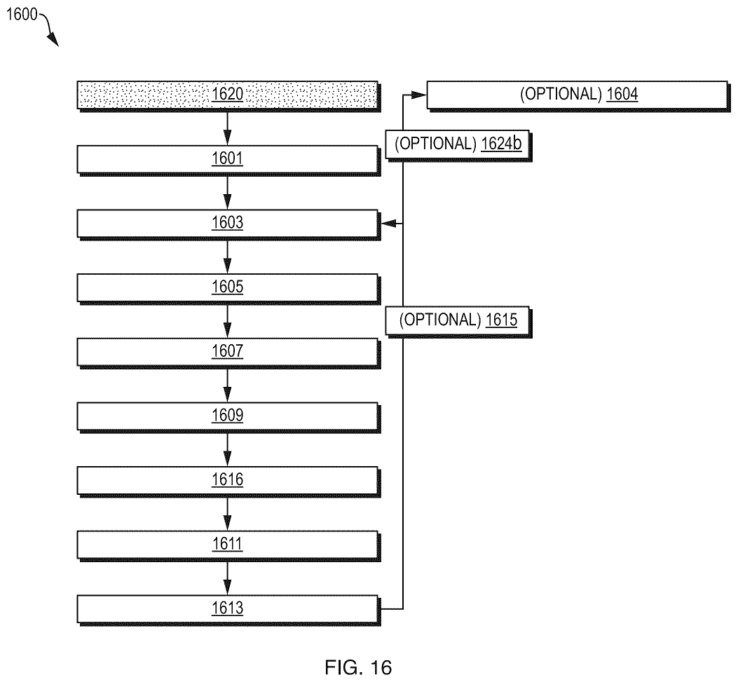

FIG. 16 is a flow diagram of a process 1600 for performing an existing conditions assessment according to an example embodiment. In an example embodiment, the process 1600 may include a component 1620 for an existing conditions assessment. According to another example embodiment, the component 1620 may identify required data 1601. In yet another example embodiment, this may include identifying the data 1601 necessary to establish a project or portfolio baseline (e.g., baseline GHG emissions, water usage, waste generation, etc.).

According to an example embodiment, the component 1620 may further obtain user/proponent held data 1603. In an example embodiment, this may include identifying the data 1603 necessary to establish a project or portfolio baseline (e.g., baseline GHG emissions, water usage, waste generation, etc.). Further, in yet another example embodiment, obtaining the data 1603 may include receiving optional input 1624b from stakeholder(s) 1604.

In an example embodiment, the component 1620 may identify data gaps 1605. According to another example embodiment, data that is not collected or maintained by a user may need to be identified 1605 (i.e., data gaps).

According to an example embodiment, the component 1620 may source or derive additional data 1607. In another example embodiment, the additional data 1607 may be sourced or derived through calculations. This task may include sourcing the data 1607 from external sources (e.g., utility organizations or Environmental Protection Agency (EPA) repositories) or developing the data 1607 based on comparable actions.

In an example embodiment, the component 1620 may categorize 1609 data. According to another example embodiment, an operator may categorize 1609 various data to organize a baseline into categories (e.g., O&M, capital projects, etc.).

According to an example embodiment, the component 1620 may establish a baseline scenario 1616. In another example embodiment, once the baseline categories 1609 are established, an operator may then establish the relevant scenario 1616 upon which the baseline(s) are defined. According to yet another example embodiment, this task 1616 can include setting a baseline year based on available data.

In an example embodiment, the component 1620 may calculate 1611 the baseline scenario 1616. According to another example embodiment, calculations 1611 may be performed to obtain the baseline scenario 1616 (e.g., electricity use may be translated to GHG emissions).

According to an example embodiment, the component 1620 may present 1613 the baseline 1616. In another example embodiment, the baseline 1616 may be presented and/or displayed 1613 in formats suitable to a user and any relevant stakeholders (e.g., graphs, tables, or other suitable known formats). For instance, the baseline 1616 may be optionally output 1615 to the stakeholder(s) 1604.

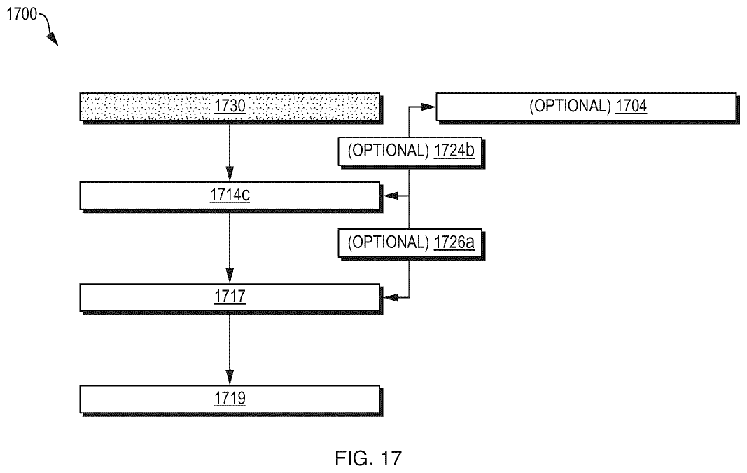

FIG. 17 is a flow diagram of a process 1700 for filtering/screening sustainable initiatives according to an example embodiment. In an example embodiment, the process 1700 may include a component 1730 to filter/screen sustainable initiatives. According to another example embodiment, the component 1730 may develop screening criteria 1714c. In yet another example embodiment, the screening criteria 1714c may be developed in conjunction with a user and/or relevant stakeholder(s) 1704. For instance, according to an example embodiment, the criteria 1714c may be based at least in part on optional input 1724b from the stakeholder(s) 1704. In another example embodiment, the criteria 1714c may include one or more exclusions that may need to be considered early in an analysis to prevent inappropriate or unsuitable options from progressing into a detailed analysis.

According to an example embodiment, the component 1730 may undertake or apply 1717 a filter/screen. In another example embodiment, the filter/screen may be completed 1717 by analyzing options and/or alternatives against the screening criteria 1714c in a rapid assessment. According to yet another example embodiment, applying 1717 the filter/screen can assign a “pass-fail” or a “yes-no” depending on the criteria 1714c. In an example embodiment, differing thresholds can be applied depending on specific desires of an analysis. For example, options that record a set number of “No” allocations may be excluded from further assessment or it may be that a single “fail” allocation excludes from further consideration. According to another example embodiment, results of applying 1717 the filter/screen may optionally be output 1726a to the stakeholder(s) 1704.

In an example embodiment, the component 1730 may document 1719 results of a filter/screen. According to another example embodiment, results of a filter/screen may be documented 1719 with clear justification for allocations that prevent an option or alternative from proceeding in a sustainability analysis.

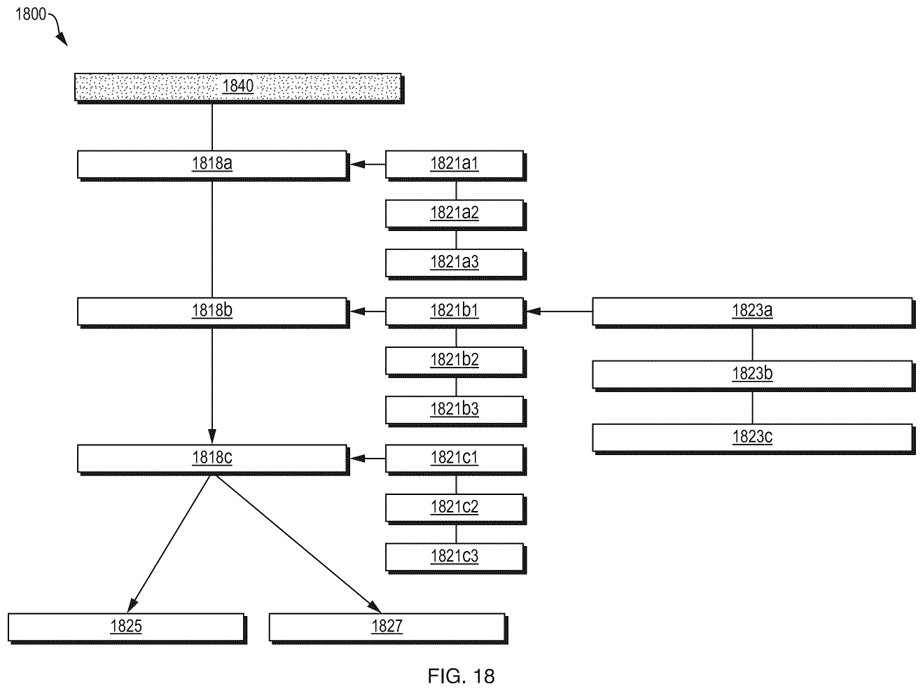

FIG. 18 is a flow diagram of a process 1800 for performing a TBL assessment according to an example embodiment. In an example embodiment, the process 1800 may include a component 1840 to perform a TBL assessment. According to another example embodiment, the process 1800 of the assessment may include an analysis of an option or initiative and benefits and/or disbenefits of that option as per each criterion. For instance, a monetary (profit) analysis 1818a may consider exemplary criteria 1821a1-1821a3, an environmental (planet) analysis 1818b may consider exemplary criteria 1821bl-1821b3, and a social (people) analysis 1818c may consider exemplary criteria 1821c1-1821c3.

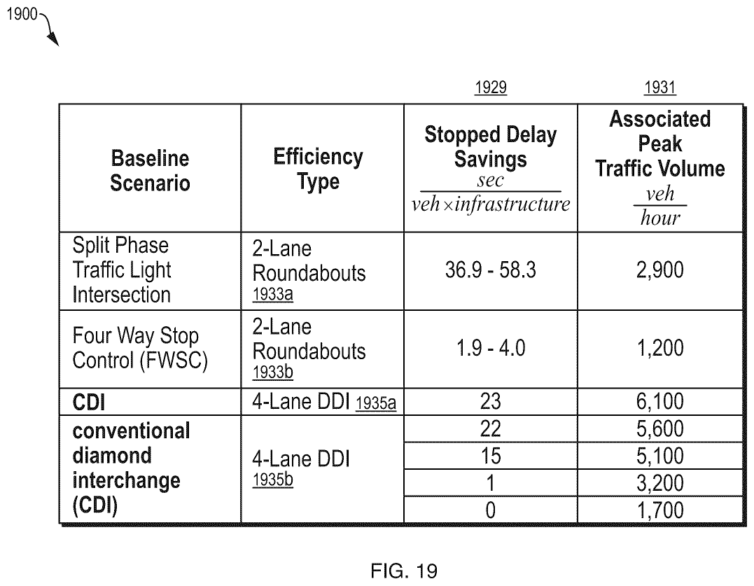

According to an example embodiment, the process 1800 may employ a detailed methodology for each initiative. For instance, the process 1800 may include developing and applying exemplary respective analysis methods 1823a, 1823b, and/or 1823c for each corresponding option/alternative. An example methodology, e.g., criteria and a method of analysis for “Prioritizing Transport Infrastructure Efficiencies,” that may be developed and used in the process 1800 is presented as follows, as well as with reference to FIG. 19, described in more detail hereinbelow:
a) CAPs Emissions—Methodology:
   i. Approach for CAPs is the same as carbon emissions. However, emission factors used for idling are different. Total CAPs is considered a sum of NOₓ, PM_{2.5}, and VOCs. An emission factor for PM_{2.5} was calculated using MOtor Vehicle Emission Simulator version 3 (MOVES3) for a passenger car at a speed of 0.5 miles per hour. Emission factors for various CAPs are as follows:
      1) NOₓ: 0.00970 milligrams per second (mg/s)
      2) PM₂0.5:0.266 mg/s (total hydrocarbon emissions are deemed equivalent to VOC emissions for purposes of this evaluation)
      3) VOCs: 0.0980 mg/s

Continuing with FIG. 18, numerous calculation methods may be available from an existing repository of information (not shown) and where an existing methodology is not available, it may be developed in the process 1800.

Continuing again with FIG. 18, the component 1840 may output results 1825, e.g., tabulated numeric results such as the table 300 (FIG. 3), for each criterion and option/alternative and/or calculation methodology descriptions 1827.

FIG. 19 is a table 1900 of stopped delay savings 1929 and associated peak traffic volume 1931 for roundabouts 1933a-1933b and diverging diamond interchanges (DDIs) 1935a-1935b according to an example embodiment. In an example embodiment, the stopped delay 1929 may include a duration of time (e.g., seconds (sec)), that a vehicle (veh) is stopped in a queue to wait to access an intersection or interchange.

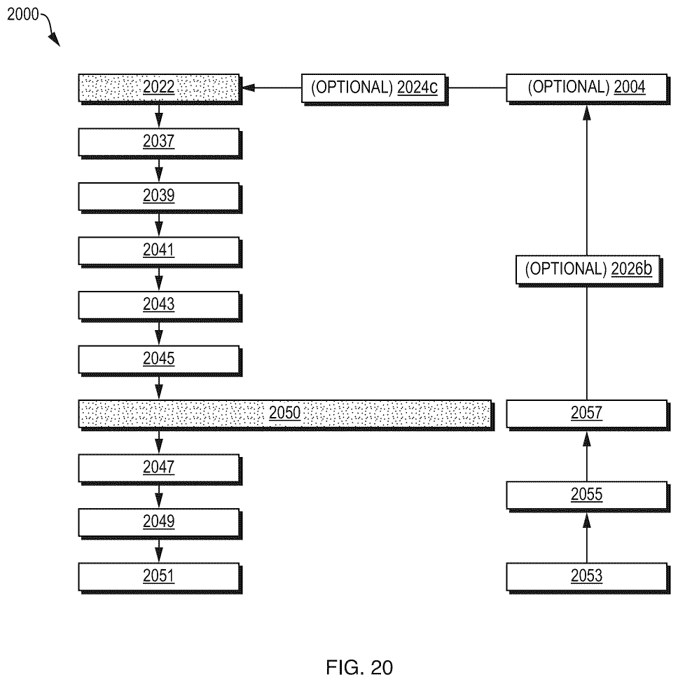

FIG. 20 is a flow diagram of a process 2000 for criteria setting/weighting and MCDA according to an example embodiment. In an example embodiment, the process 2000 may include a component 2022 for criteria setting. According to another example embodiment, the component 2022 may nominate potential criteria 2037, consider relevance 2039 of criteria for an analysis, identify weighting 2041 for criteria, garner input and evaluation 2043 of weights, and finalize 2045 criteria weights.

In an example embodiment, criteria to be used in an analysis may be identified and selected by the component 2022. According to another example embodiment, although criteria may be driven by user/proponent preferences, they may also account for TBL categories (i.e., economic, environmental, and social) to appropriately account for sustainability. In yet another example embodiment, this step may involve the following:
a) Workshops
b) Brainstorming sessions
c) Surveys
d) Questionnaires

According to an example embodiment, a basis for the criteria and weightings may be documented. In another example embodiment, weightings for an analysis may be established out of 100%. For instance:
a) Example Criteria 1-15% weighting
b) Example Criteria 2-35% weighting
c) Example Criteria 3-45% weighting
d) Example Criteria 4-5% weighting

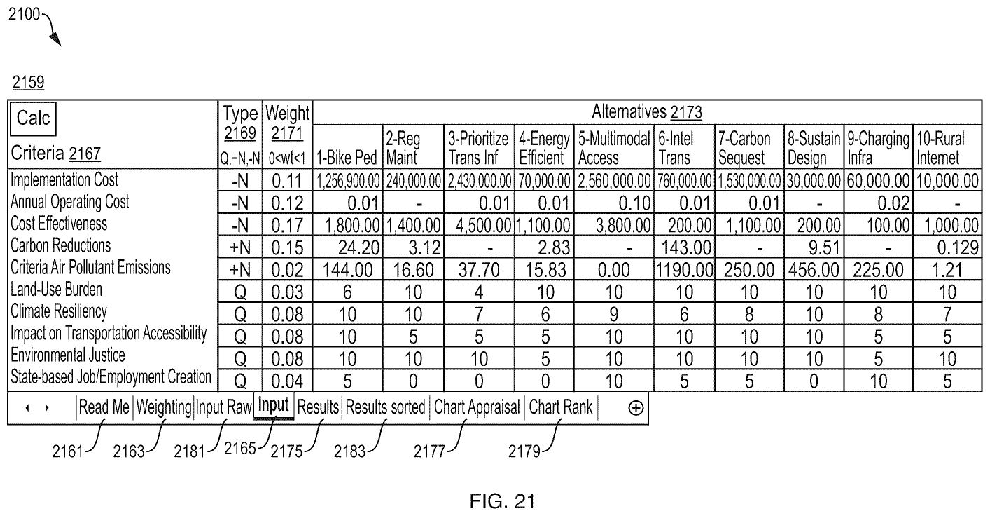

FIG. 21 is a user interface 2100 for an automated analysis tool according to an example embodiment. As shown in FIG. 21, in an example embodiment, the interface 2100 may include a calculation function 2159, a “read me” tab 2161 (e.g., providing instructions for review for employing the automated analysis tool), a weighting tab 2163, and an input tab 2165. In turn, according to another example embodiment, the input tab 2165 may include criteria 2167 fields, type 2169 fields, weight 2171 fields, and alternatives 2173 fields. According to yet another example embodiment, data types—e.g., numerical (positive/negative) or qualitative—may be inserted into the type 2169 fields. In an example embodiment, the weight 2171 fields may include weightings applied as numerical values. According to another example embodiment, each sustainability option/alternative may be assigned a separate column in the alternatives 2173 fields. In yet another example embodiment, the automated analysis tool may utilize EVAMIX.

According to an example embodiment, the interface 2100 may provide stakeholders and decisionmakers with an unbiased process for evaluating and ranking options, based on quantitative and/or qualitative criteria. In another example embodiment, to use the interface 2100, the following information may be entered:
a) Options to be evaluated (i.e., in the alternatives 2173 fields)
b) Criteria-quantitative and/or qualitative-used to evaluate options (i.e., in the criteria 2167 fields)
c) Relative importance (i.e., weight) of each criteria (i.e., in the weight 2171 fields)
d) A score of each criteria for every option

Continuing with FIG. 21, in an example embodiment, data may be entered in the input tab 2165. According to another example embodiment, results may be calculated using the following data entered on the input tab 2165:
a) Names of options in the alternatives 2173 fields
b) Names of criteria in the criteria 2167 fields
c) Types of criteria in the type 2169 fields
   i. ‘Q’ may indicate qualitative criteria
   ii. ‘+N’ may indicate numeric (quantitative) criteria where a larger value is better
   iii. ‘−N’ may indicate numeric criteria where a smaller value is better
d) Relative weights (wt) of each criteria (0<wt<1) in the weight 2171 fields
e) Scores of each criteria for each option in the alternatives 2173 fields
   i. For qualitative values, (i.e., environmental impact, aesthetic value), an integer may be entered using either of the following scales for all options:
      1) Very undesirable (1), undesirable (2), neutral (3), preferred (4), strongly preferred (5); or
      2) Bad (1), neutral (2), good (3)
   ii. For numeric values (i.e., cost, acreage, pumping rate) a positive real number may be entered.

Continuing with FIG. 21, in an example embodiment, new appraisal values and ranks may be calculated and displayed on in results tab 2175:
a) “rank” may indicate relative desirability of each option (1 may indicate best)
b) “appraisal value” may indicate a calculated value on which a ranking is based

According to an example embodiment, one of two exemplary methods may be used to calculate appraisal values and ranks as follows:
a) Exemplary Method 1—Subtracted Summation
b) Exemplary Method 2—Subtracted Shifted Interval

In an example embodiment, in general, the above two exemplary methods may give different appraisal values, but the same or similar ranks. According to another example embodiment, appraisal values of a method are almost the same for certain options, the options may be viewed as having the same rank. (In yet another example embodiment, chart appraisal tab 2177 may be used to evaluate this.) According to an example embodiment, when the above two exemplary methods give different ranks, the ranking difference may not be significant. (In another example embodiment, chart rank tab 2179 may be used to evaluate this.)

Continuing with FIG. 21, in an example embodiment, an input raw tab 2181 may be provided for initial work with input data. According to another example embodiment, a results sorted tab 2183 may be provided for sorting and formatting output data.

Referring again to FIG. 20, in an example embodiment, the process 2000 may include a MCDA component 2050. According to another example embodiment, the component 2050 may initialize 2047 an analysis tool having a user interface, e.g., the user interface 2100 (FIG. 21). In yet another example embodiment, criteria and weighting may be input 2049 into, e.g., the weighting tab 2163 (FIG. 21), which may serve as a repository for criteria and weightings used in an analysis. According to an example embodiment, criteria, corresponding weighting, and alternatives and numerical values may be input 2051 into, e.g., respective fields 2167 (FIG. 21), 2171 (FIG. 21), and 2173 (FIG. 21) of the input raw tab 2181 (FIG. 21), which may be an operational tab that serves as a repository for all input data. In another example embodiment, data can be manipulated in the input raw tab 2181 prior to inputting into the input tab 2165 (FIG. 21). According to yet another example embodiment, the input tab 2165 may be populated 2053 with data and the calculation function 2159 (FIG. 21) may be used. In an example embodiment, automatic results, option rankings, and appraisal charts may be analyzed 2055. According to another example embodiment, results may be tabulated and/or graphed 2057 for reporting and decision-making.

Continuing with FIG. 20, in an example embodiment, the results 2057 may be provided as optional output 2026b to the stakeholders 2004. According to another example embodiment, setting of criteria and weightings may involve internal and/or external project stakeholders to the greatest extent possible. In yet another example embodiment, stakeholder engagement and acceptance techniques may be utilized to firstly confirm criteria that are used in an MCDA, e.g., 150 (FIG. 1) or 2050 (FIG. 2), and then weighting of that criteria.

### Exemplary Implemented Projects

A SAF of embodiments, e.g., the framework 100 (FIG. 1), has been implemented on several exemplary projects, highlighting a technical robustness of the framework. For each project in which it was implemented, a framework was included in a proposal technical scope submittal and carried through into the project's work plan (if applicable) and project deliverables. This is further discussed below.

For each project in which a framework is implemented, the most recent project benefits from previous ones via, for instance:
a) Filter and Screen, e.g., the filter/screen process 130 (FIG. 1), and TBL criteria assessment, e.g., the TBL assessment 140 (FIG. 1), methodologies previously developed can be performed in a significantly shorter period of time.
b) Filter and Screen, e.g., the filter/screen process 130, and TBL criteria assessment, e.g., the TBL assessment 140, methodologies can be easily modified to create new methodology in a significantly shorter period of time.
c) Assessment calculations and results may be stored or serialized in a format, e.g., Excel® or other suitable known format, that can be easily integrated with, e.g., Power BI or other suitable known tool, to create a data visualization dashboard, e.g., the dashboard 500 (FIG. 5) or 600 (FIG. 6).
d) An established SAF, e.g., the framework 100, can enable new internal staff/team members to easily pick up the system and apply it on their projects with minimal oversight. This can enable broader application of the system within Applicant-Assignee's business in a cost-effective manner that also maintains scientific integrity of sustainability analyses performed by Applicant-Assignee.

As noted, a SAF, e.g., the framework 100, can be implemented in user proposal technical scopes of work (SoWs) and project deliverables to identify, prioritize, monitor, and report sustainability strategy/solutions (e.g., decarbonization, net zero energy, water and waste, water reuse, carbon reduction, climate action, etc.). A SAF has been applied to projects across all of Applicant-Assignee's service groups and business units.

A start to finish example is the Ohio Department of Transportation Carbon Reduction Strategy project. Applicant-Assignee applied a SAF, e.g., the framework 100, in its entirety to develop this planning document in accordance with the Bipartisan Infrastructure Law Carbon Reduction Program requirement and informed by multiple stakeholder input. The final document is publicly available as Ohio Department of Transportation, “Ohio Carbon Reduction Strategy,” Nov. 6, 2023. Subsequently, Applicant-Assignee was able to develop the Michigan Department of Transportation Carbon Reduction Strategy.

Applicant-Assignee also provides a SAF, e.g., the framework 100, overlaid with, e.g., Power BI, to help users monitor and report on active sustainability initiatives, including in Applicant-Assignee's Transformational Growth Areas for Clean Energy. For example, Applicant-Assignee was selected for Program Management of New York Power Authority's 15 Site Decarbonization Portfolio, in which a SAF/Power BI are to be used to help manage (monitor and report on) the portfolio. A SAF is also being actively provided to industrial users to support compliance and/or voluntary sustainability reporting and Applicant-Assignee's North American Unit users to support climate action plan development.

### Exemplary Method Embodiment

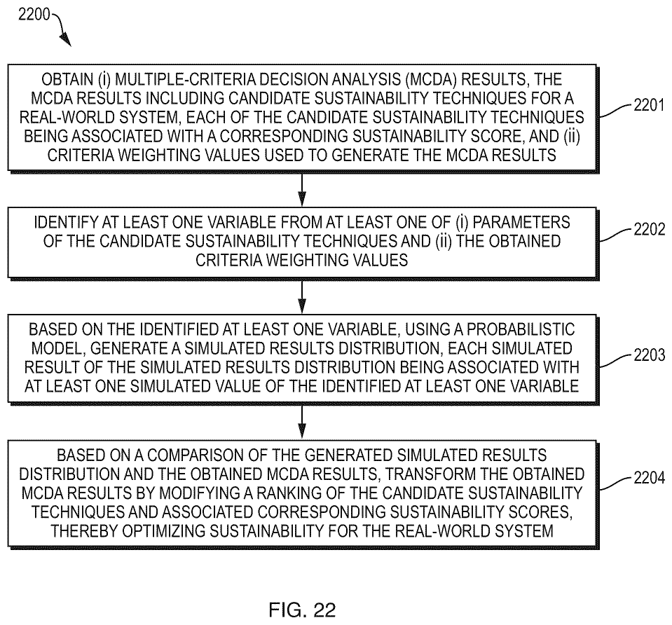

FIG. 22 is a flowchart of a method 2200 for optimizing sustainability for a real-world system according to an example embodiment. The method 2200 is computer-implemented and may be implemented using any computing device, e.g., a processor or combination of computing devices known to those of skill in the art.

The method 2200 begins at step 2201 by obtaining (i) MCDA results, e.g., the exemplary MCDA results of Tables 3-5 (described hereinabove), the MCDA results 438 (FIG. 4), or the results 2175 (FIG. 21), and (ii) criteria weighting values used to generate the MCDA results, e.g., the exemplary weighting values of Tables 1A-1C (described hereinabove), the exemplary weighting values of table 300 (FIG. 3), the weightings 2163 (FIG. 21), or the weightings 2171 (FIG. 21). The MCDA results include candidate sustainability techniques for the real-world system, e.g., the exemplary sustainability techniques of Tables 3-5. Each of the candidate sustainability techniques is associated with a corresponding sustainability score, e.g., the exemplary sustainability scores of Tables 3-5. At step 2202, the method 2200 identifies at least one variable, e.g., at least one variable with a higher or lower uncertainty value, from at least one of (i) parameters of the candidate sustainability techniques and (ii) the obtained criteria weighting values, e.g., the data/variables 454 (FIG. 4). In turn, at step 2203, based on the identified at least one variable, using a probabilistic model, the method 2200 generates a simulated results distribution, e.g., the probabilistic spread of results 456 (FIG. 4). According to an example embodiment, the probabilistic model-such as a Monte Carlo model—may execute, e.g., thousands, of simulations and generate, e.g., thousands, of results. To continue, each simulated result of the simulated results distribution is associated with at least one simulated value of the identified at least one variable. At step 2204, based on a comparison of the generated simulated results distribution and the obtained MCDA results, the method 2200 then transforms the obtained MCDA results by modifying a ranking of the candidate sustainability techniques and associated corresponding sustainability scores, thereby optimizing sustainability for the real-world system. In an example embodiment, the method 2200 may determine that, for instance, in 95% of generated simulations, the same three candidate sustainability techniques have the highest corresponding sustainability scores. According to another example embodiment, the method 2200 may, after comparing the generated simulated results distribution and the obtained MCDA results, identify a misalignment between the former and the latter and thus determine that uncertainty exists in the obtained MCDA results—e.g., that the obtained MCDA results are sensitive to variations or changes in input data or parameters and accordingly the candidate sustainability techniques may require further analysis. In yet another example embodiment, if the comparison indicates a large number of changes in the generated simulated results relative to the obtained MCDA results, then the method 2200 may use the generated simulated results distribution to alter or adjust corresponding sustainability scores for the candidate sustainability techniques in the obtained MCDA results.

In an example embodiment of the method 2200, the probabilistic model may be a Monte Carlo model, a stochastic simulation model, another probabilistic model, or a combination thereof.

According to an example embodiment, the method 2200 may further include identifying the at least one variable based on a value of the at least one variable meeting or exceeding a threshold value.

In an example embodiment, the method 2200 may further include storing the generated simulated results distribution in a metrics repository. According to another example embodiment, the method 2200 may further include generating the simulated results distribution based on at least one metric stored in a metrics repository. Further, in yet another example embodiment, simulated/calculated results or data stored in a metrics repository may later be used to refine methodologies or techniques, such as various probabilistic models and other approaches for optimizing sustainability for real-world systems; similarly, a repository may be updated with new climate or sustainability data as the data becomes available.

According to an example embodiment of the method 2200, the criteria weighting values may be TBL criteria weighting values relating to the real-world system.

In an example embodiment of the method 2200, the real-world system may be a transportation system, a waste management system, a water system, an energy system, an industrial system, an ecosystem, or a natural resource system.

According to an example embodiment, the method 2200 may further include outputting a graph representing the generated simulated results distribution. In another example embodiment, the graph may visualize, e.g., thousands, of simulations. According to yet another example embodiment, the graph may indicate, e.g., a range of the probabilistic model, an upper bound, a lower bound, and/or a median of the simulated results.

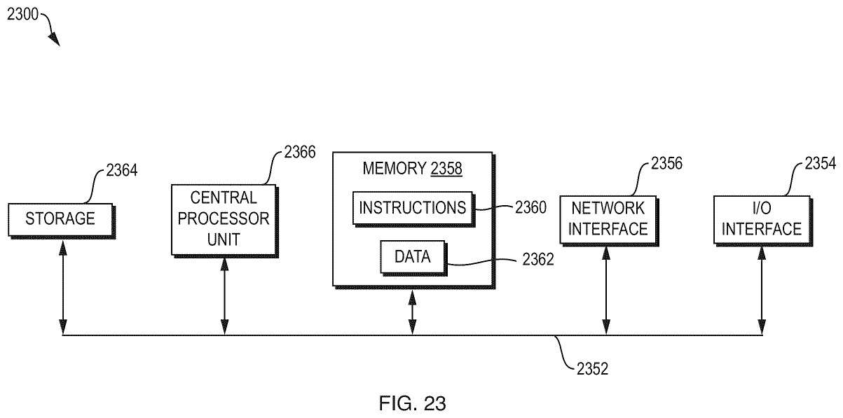

As noted above, the method 2200 is computer implemented and, as such, the functionality and effective operations, e.g., the obtaining (2201), identifying (2202), generating (2203), and transforming (2204), are automatically implemented by one or more digital processors. Moreover, the method 2200 can be implemented using any computing device or combination of computing devices known in the art. Among other examples, the method 2200 can be implemented using a computer 2300 described hereinbelow in relation to FIG. 23.

### Computer Support

FIG. 23 is a block diagram of an example embodiment of an internal structure of a computer 2300 in which various embodiments of the present disclosure may be implemented. The computer 2300 contains a system bus 2352, where a bus is a set of hardware lines used for data transfer among the components of a computer or digital processing system. The system bus 2352 is essentially a shared conduit that connects different elements of a computer system (e.g., processor, disk storage, memory, input/output (I/O) ports, network ports, etc.) that enables the transfer of information between the elements. Coupled to the system bus 2352 is an I/O device interface 2354 for connecting various input and output devices (e.g., keyboard, mouse, displays, printers, speakers, etc.) to the computer 2300. A network interface 2356 allows the computer 2300 to connect to various other devices attached to a network (e.g., global computer network, wide area network, local area network, etc.). A memory 2358 provides volatile or non-volatile storage for computer software instructions 2360 and data 2362 that may be used to implement embodiments (e.g., the framework 100 (FIG. 1), the method 400 (FIG. 4), the dashboard 500 (FIG. 5), the dashboard 600 (FIG. 6), the calculator 1000 (FIG. 10), the calculator 1100 (FIG. 11), the calculator 1200 (FIG. 12), the process 1500 (FIG. 15), the process 1600 (FIG. 16), the process 1700 (FIG. 17), the process 1800 (FIG. 18), the process 2000 (FIG. 20), the user interface 2100 (FIG. 21), the method 2200 (FIG. 22), etc.) of the present disclosure, where the volatile and non-volatile memories are examples of non-transitory media. A disk storage 2364 provides non-volatile storage for the computer software instructions 2360 and data 2362. A central processor unit 2366 is also coupled to the system bus 2352 and provides for execution of computer instructions, e.g., the computer software instructions 2360.

As used herein, the terms “framework” and “tool” may refer to any hardware, software, firmware, electronic control component, processing logic, and/or processor device, individually or in any combination, including without limitation: an application specific integrated circuit (ASIC), a field-programmable gate array (FPGA), an electronic circuit, a processor and memory that executes one or more software or firmware programs, and/or other suitable components that provide the described functionality.

Example embodiments disclosed herein may be configured using a computer program product; for example, controls may be programmed in software for implementing example embodiments. Further example embodiments may include a non-transitory computer-readable medium that contains instructions that may be executed by a processor, and, when loaded and executed, cause the processor to complete methods described herein. It should be understood that elements of the block and flow diagrams may be implemented in software or hardware, such as via one or more arrangements of circuitry of FIG. 16, disclosed above, or equivalents thereof, firmware, a combination thereof, or other similar implementation determined in the future.

In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as random-access memory (RAM), read-only memory (ROM), compact disk read-only memory (CD-ROM), and so forth. In operation, a general purpose or application-specific processor or processing core loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments disclosed herein.

The teachings of all patents, published applications, and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A computer-based system for optimizing sustainability for a real-world system, the computer-based system comprising:
at least one processor; and
a memory with computer code instructions stored thereon, the at least one processor and the memory, with the computer code instructions, being configured to cause the computer-based system to:
obtain (i) multiple-criteria decision analysis (MCDA) results, the MCDA results including candidate sustainability techniques for the real-world system, each of the candidate sustainability techniques being associated with a corresponding sustainability score, and (ii) criteria weighting values used to generate the MCDA results;
identify at least one variable from at least one of (i) parameters of the candidate sustainability techniques and (ii) the obtained criteria weighting values;
based on the identified at least one variable, using a probabilistic model, generate a simulated results distribution, each simulated result of the simulated results distribution being associated with at least one simulated value of the identified at least one variable; and
based on a comparison of the generated simulated results distribution and the obtained MCDA results, transform the obtained MCDA results by modifying a ranking of the candidate sustainability techniques and associated corresponding sustainability scores, thereby optimizing sustainability for the real-world system.

2. The computer-based system of claim 1, wherein the probabilistic model is a Monte Carlo model, a stochastic simulation model, another probabilistic model, or a combination thereof.

3. The computer-based system of claim 1, wherein the at least one processor and the memory, with the computer code instructions, are further configured to cause the computer-based system to:
identify the at least one variable based on a value of the at least one variable meeting or exceeding a threshold value.

4. The computer-based system of claim 1, wherein the MCDA results are generated using an EVAluation of MIXed data (EVAMIX) model based on the parameters of the candidate sustainability techniques and the criteria weighting values.

5. The computer-based system of claim 1, wherein the at least one processor and the memory, with the computer code instructions, are further configured to cause the computer-based system to:
store the generated simulated results distribution in a metrics repository.

6. The computer-based system of claim 1, wherein the at least one processor and the memory, with the computer code instructions, are further configured to cause the computer-based system to:
generate the simulated results distribution based on at least one metric stored in a metrics repository.

7. The computer-based system of claim 1, wherein the criteria weighting values are triple bottom line (TBL) criteria weighting values relating to the real-world system.

8. The computer-based system of claim 1, wherein the real-world system is a transportation system, a waste management system, a water system, an energy system, an industrial system, an ecosystem, or a natural resource system.

9. The computer-based system of claim 1, wherein the at least one processor and the memory, with the computer code instructions, are further configured to cause the computer-based system to:
output a graph representing the generated simulated results distribution.

10. A computer-implemented method for optimizing sustainability for a real-world system, the computer-implemented method comprising:
obtaining (i) multiple-criteria decision analysis (MCDA) results, the MCDA results including candidate sustainability techniques for the real-world system, each of the candidate sustainability techniques being associated with a corresponding sustainability score, and (ii) criteria weighting values used to generate the MCDA results;
identifying at least one variable from at least one of (i) parameters of the candidate sustainability techniques and (ii) the obtained criteria weighting values;
based on the identified at least one variable, using a probabilistic model, generating a simulated results distribution, each simulated result of the simulated results distribution being associated with at least one simulated value of the identified at least one variable; and
based on a comparison of the generated simulated results distribution and the obtained MCDA results, transforming the obtained MCDA results by modifying a ranking of the candidate sustainability techniques and associated corresponding sustainability scores, thereby optimizing sustainability for the real-world system.

11. The computer-implemented method of claim 10, wherein the probabilistic model is a Monte Carlo model, a stochastic simulation model, another probabilistic model, or a combination thereof.

12. The computer-implemented method of claim 10, wherein:
identifying the at least one variable is based on a value of the at least one variable meeting or exceeding a threshold value.

13. The computer-implemented method of claim 10, wherein the MCDA results are generated using an EVAluation of MIXed data (EVAMIX) model based on the parameters of the candidate sustainability techniques and the criteria weighting values.

14. The computer-implemented method of claim 10, further comprising:
storing the generated simulated results distribution in a metrics repository.

15. The computer-implemented method of claim 10, wherein:
generating the simulated results distribution is based on at least one metric stored in a metrics repository.

16. The computer-implemented method of claim 10, wherein the criteria weighting values are triple bottom line (TBL) criteria weighting values relating to the real-world system.

17. The computer-implemented method of claim 10, wherein the real-world system is a transportation system, a waste management system, a water system, an energy system, an industrial system, an ecosystem, or a natural resource system.

18. The computer-implemented method of claim 10, further comprising:
outputting a graph representing the generated simulated results distribution.

19. A non-transitory computer program product for optimizing sustainability for a real-world system, the non-transitory computer program product comprising a computer-readable medium with computer code instructions stored thereon, the computer code instructions being configured, when executed by at least one processor, to cause the at least one processor to:
obtain (i) multiple-criteria decision analysis (MCDA) results, the MCDA results including candidate sustainability techniques for the real-world system, each of the candidate sustainability techniques being associated with a corresponding sustainability score, and (ii) criteria weighting values used to generate the MCDA results;
identify at least one variable from at least one of (i) parameters of the candidate sustainability techniques and (ii) the obtained criteria weighting values;
based on the identified at least one variable, using a probabilistic model, generate a simulated results distribution, each simulated result of the simulated results distribution being associated with at least one simulated value of the identified at least one variable; and
based on a comparison of the generated simulated results distribution and the obtained MCDA results, transform the obtained MCDA results by modifying a ranking of the candidate sustainability techniques and associated corresponding sustainability scores, thereby optimizing sustainability for the real-world system.

20. The non-transitory computer program product of claim 19, wherein the probabilistic model is a Monte Carlo model, a stochastic simulation model, another probabilistic model, or a combination thereof.
